(19) United States
(12) Patent Application Publication
(10) Pub. No.: US 2022/0191696 A1
(43) Pub. Date: Jun. 16, 2022

(54) METHODS AND PROCESS OF VERIFYING MULTI-SIM DEVICE AND SUBSCRIPTION INFORMATION

(71) Applicant: NEC Corporation, Minato-ku, Tokyo (JP)

(72) Inventors: Takahito YOSHIZAWA, Heidelberg (DE); Shubhranshu SINGH, Heidelberg (DE); Sander DE KIEVIT, Tokyo (JP)

(73) Assignee: NEC Corporation, Minato-ku, Tokyo (JP)

(21) Appl. No.: 17/605,038

(22) PCT Filed: Apr. 30, 2019
(86) PCT No.: PCT/IB2019/053548

§ 371 Date: Oct. 20, 2021

(51) Int. Cl. H04W 12/069; H04W 12/72; H04L 9/32

(52) U.S. Cl. CPC H04W 12/069; H04W 88/06; H04L 9/3213; H04W 12/72

(57) ABSTRACT

Provided is a user equipment (UE) including a first Subscriber Identity Module (SIM) and a second SIM, the UE is configured to receive, from a network node, a first token derived from a seed token using a first cryptographic key associated with the first SIM; derive a first third order token by encrypting the received first token using a second cryptographic key associated with the second SIM; and send the third order token to the network node.

### BACKGROUND

### Technical Field

The present invention relates to a wireless communication system and devices thereof operating according to the 3rd Generation Partnership Project (3GPP) standards or equivalents or derivatives thereof. The disclosure has particular but not exclusive relevance to improvements relating to multi-SIM devices (multi-SIM user equipment) in the so-called ‘5G’ (or ‘Next Generation’) systems.

### Description of the Related Art

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT) communications, vehicular communications and autonomous cars, high resolution video streaming, smart city services, and/or the like. 5G technologies enable network access to vertical markets and support network (RAN) sharing for offering networking services to third parties and for creating new business opportunities. 3GPP intends to support 5G by way of the so-called 3GPP Next Generation (NextGen) radio access network (RAN) and the 3GPP NextGen core (NGC) network.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V15.5.0 and TS 37.340 V15.5.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

3GPP also defined the so-called ‘Xn’ interface as the network interface between neighbouring NG-RAN nodes.

End-user communication devices are commonly referred to as User Equipment (UE) which may be operated by a human or comprise automated (MTC/IoT) devices. There have been multi-SIM capable mobile devices (UEs) in the market in the past years. They provide the ability to use and manage multiple subscriptions in a single device. With the conventional mobile phone that can accommodate only 1 SIM card, a user needs to carry multiple devices when he/she uses multiple subscriptions. One notable example is a business person who carries multiple mobile phones, one for personal use and another for business use (e.g. company-provided phone). In such scenario, multi-SIM capable device provides a convenience to carry only one mobile phone even in such situation.

Typically, a multi-SIM capable mobile device is equipped with two SIM card slots, thus it is also generally referred to as a ‘dual-SIM phone’. In another UE implementation, the mobile device is equipped with one SIM card slot and another SIM functionality is embedded in hardware (‘eSIM’). The mobile device may have an individual IMEI for each SIM, or a single IMEI common to all SIMs in the mobile device. One example of having single IMEI common to all SIMs is when a single UICC card contains multiple USIM applications.

Thus far, the operation and behavior of these multi-SIM capable mobile devices are not standardized in 3GPP and thus they are implementation (manufacturer) dependent. The exact T_{X} and R_{X} operation, and simultaneous use of two subscriptions are largely driven by the hardware implementation. GSMA document in [10] defines three types of multi-SIM devices:
Passive: only 1 SIM can be selected at a time, effectively a single SIM device as it does not allow simultaneous use of 2 SIMs. The SIMs share a single transceiver and have only one logical connection to a single network at a time.
Dual SIM Dual Standby (DSDS): both SIMs can be used for idle-mode network connection, but when a radio connection is active, the second connection is disabled. The SIMs share a single transceiver. Through multiplexing, two radio connections are maintained in idle-mode. When in-call on network for one SIM, it is no longer possible to maintain radio connection with the network of the second SIM. Registration to the second SIM is maintained.
Dual SIM Dual Active (DSDA): both SIMs can be used in both idle-mode and connected-mode. Each SIM has dedicated transceiver, thus there is no inter-dependence between the idle or connected-mode operations of the two SIMs at the modem level.

The differences of these operational modes depend on the number of T_{X} and R_{X} chain in the transceiver implementation in the mobile device. The first and second cases implies single T_{X}/R_{X} chain, and the third case implies dual R_{X}/T_{X} chains, respectively.

Subscriptions, call events, billing, and management of the SIM cards are completely independent because the network is not aware of such multi-SIM capable devices. Therefore, use of such device leads to operational implications, for example, how the UE reacts if call events on these subscriptions occurs simultaneously, such as: 1) if two subscriptions are paged simultaneously or within a brief interval; 2) if one subscription is paged while a call is in progress for the other subscription. There are likely other scenarios that impact the behavior of multi-SIM device involving multiple subscriptions.

In addition, GSMA has a set of requirements for multi-SIM devices [10] as follows:
Blocking of all service access from one of the device's IMEIs SHALL result in the entire device being blocked. Specifically, if a device receives reject #6 “Illegal ME” over one 3GPP/connection, it SHALL block operation on all 3GPP/3GPP2 connections. Similarly, if a Lock until Power-Cycled Order is received over one 3GPP2 connection, the device SHALL block operation on all 3GPP/3GPP2 connections. (TS37_2.2_REQ_1)
When blocking operation on 3GPP/3GPP2 connections other than the one that triggered the blocking, the device SHALL follow standard 3GPP/3GPP2 protocols. Specifically any active traffic SHALL be immediately terminated using normal signalling and then a network detach performed. (TS37_2.2_REQ_2)

The above requirements imply that the network needs to be aware of multi-SIM devices and need to be able to correlate multiple IMSIs that belong to the same device so that service to all IMEIs can be blocked or ongoing call can be terminated. The reason of blocking may include, for example, a lost or stolen mobile device, a customer being delinquent in subscription fee payment, etc.

One possible outcome of standardization is to define coordination at the system level of these multiple subscriptions within such multi-SIM capable devices. This may include defining mechanisms and procedures to make the network to be aware of such devices in order to allow the network to coordinate call processing events and thus avoid problems or enhance user experience.

In order for the network to become aware of such multi-SIM capable devices, there needs to be a mechanism in place to identify such devices and verify the associated subscriptions together. However, because the usage and operation of these multi-SIM devices has not been standardized, no such mechanism exists yet to achieve such identification and verification. A few possible mechanisms for the network to be aware of the multi-SIM devices are: 1) UE to spontaneously report whether the mobile device is equipped with the multi-SIM capability or not; or 2) the network to query the mobile device and the device responds back whether the device is equipped with the multi-SIM capability or not. However, such mechanism has potential security issues. It is because the network relies on the information provided by the UE and blindly accepts the information simply because the network has no way to verify whether the information provided by the mobile device is real or not. This situation opens possible opportunities by fake devices to attack the network. In other words, this situation leaves a potential security threat where rogue devices are able to: 1) report multi-SIM capability even when it is not; and/or 2) intentionally report incorrect subscription information associated with the SIM cards inserted in the mobile device in order to make the network believe the association of subscriptions being in a single mobile device.

The inventors have realized that there needs to be a security mechanism in place to verify multi-SIM capable UEs and unequivocally identify and verify the subscription information of the SIM cards inserted in the mobile device. In other words, the network needs to be able to verify if and what subscription information resides in the SIM cards in a multi-SIM mobile device.

### SUMMARY

Accordingly, the present invention seeks to provide methods and associated apparatus that address or at least alleviate (at least some of) the following issues:
1) identification of USIMs inserted in a multi-SIM capable mobile device;
2) determining and re-verifying any change of USIMs in a multi-SIM capable mobile device; and
3) identifying USIMs in a multi-SIM device when multiple MNOs are involved.

In one aspect, the invention provides a method performed by a user equipment (UE) comprising at least a first Subscriber Identity Module (SIM) and a second SIM, the method comprising: receiving, from a network node, at least a first token (T_{A}) derived from a seed token (T_{S}) using a first cryptographic key (K_{A}, K_{NASenc_A}) associated with the first SIM; deriving a first third order token (T_{AB}) by encrypting the received first token (T_{A}) using a second cryptographic key (K_{B}, K_{NASenc_B}) associated with the second SIM; and sending said third order token (T_{AB}) to the network node.

In one aspect, the invention provides a method performed by a network node communicating with a user equipment (UE) comprising at least a first Subscriber Identity Module (SIM) and a second SIM, the method comprising: sending, to said UE, at least a first token (T_{A}) derived from a seed token (T_{S}) using a first cryptographic key (K_{A}, K_{NASenc_A}) associated with the first SIM; and receiving, from said UE, a first third order token (T_{AB}) derived by the UE by encrypting the first token (T_{A}) using a second cryptographic key (K_{B}, K_{NASenc_B}) associated with the second SIM.

In one aspect, the invention provides a method performed by a user equipment (UE) comprising at least a first Subscriber Identity Module (SIM) and a second SIM, the method comprising: receiving, from a network node, a first token (T_{A}) derived from a seed token (T_{S}) using a first cryptographic key (K_{A}, K_{NAsenc_A}) associated with the first SIM; decrypting said first token (T_{A}) using said first cryptographic key (K_{A}, K_{NASenc_A}) associated with the first SIM to derive the seed token (T_{S}); deriving a second token (T_{B}) by encrypting the derived seed token (T_{S}) using a second cryptographic key (K_{B}, K_{NASenc_A}) associated with the second SIM; and sending said second token (T_{B}) to the network node.

In one aspect, the invention provides a method performed by a network node communicating with a user equipment (UE) comprising at least a first Subscriber Identity Module (SIM) and a second SIM, the method comprising: sending, to said UE, a first token (T_{A}) derived from a seed token (T_{S}) using a first cryptographic key (K_{A}, K_{NASenc_A}) associated with the first SIM; and receiving, from said UE, a second token (T_{B}) derived by the UE by decrypting said first token (T_{A}) using said first cryptographic key (K_{A}, K_{NASenc_A}) associated with the first SIM to derive the seed token (T_{S}) and by encrypting the derived seed token (T_{S}) using a second cryptographic key (K_{B}, K_{NAsenc_B}) associated with the second SIM.

In one aspect, the invention provides a method performed by a network node associated with a first mobile network operator (MNO) communicating with a user equipment (UE) comprising a first Subscriber Identity Module (SIM) associated with the first MNO and a second SIM associated with a second MNO, the method comprising: performing a registration procedure with the UE using the first SIM; obtaining information indicating that the UE includes said second SIM associated with the second MNO; and receiving, from a node of said second MNO, information indicating whether or not the second SIM associated with the second MNO is blocked.

In one aspect, the invention provides a user equipment (UE) comprising at least a first Subscriber Identity Module (SIM) and a second SIM, a controller, and a transceiver, wherein the controller is configured to: receive, from a network node, at least a first token (T_{A}) derived from a seed token (T_{S}) using a first cryptographic key (K_{A}, K_{NASenc_A}) associated with the first SIM; derive a first third order token (T_{AB}) by encrypting the received first token (T_{A}) using a second cryptographic key (K_{B}, K_{NAsenc_B}) associated with the second SIM; and send said third order token (T_{AB}) to the network node.

In one aspect, the invention provides a network node communicating with a user equipment (UE) comprising at least a first Subscriber Identity Module (SIM) and a second SIM, the network node comprising a controller and a transceiver, wherein the controller is configured to: send, to said UE, at least a first token (T_{A}) derived from a seed token (T_{S}) using a first cryptographic key (K_{A}, K_{NAsenc_A}) associated with the first SIM; and receive, from said UE, a first third order token (T_{AB}) derived by the UE by encrypting the first token (T_{A}) using a second cryptographic key (K_{B}, K_{NAsenc_B}) associated with the second SIM.

In one aspect, the invention provides a user equipment (UE) comprising at least a first Subscriber Identity Module (SIM) and a second SIM, a controller, and a transceiver, wherein the controller is configured to: receive, from a network node, a first token (T_{A}) derived from a seed token (T_{S}) using a first cryptographic key (K_{A}, K_{NASenc_A}) associated with the first SIM; decrypt said first token (T_{A}) using said first cryptographic key (K_{A}, K_{NASenc_A}) associated with the first SIM to derive the seed token (T_{S}); derive a second token (T_{B}) by encrypting the derived seed token (T_{S}) using a second cryptographic key (K_{B}, K_{NASenc_B}) associated with the second SIM; and send said second token (T_{B}) to the network node.

In one aspect, the invention provides a network node communicating with a user equipment (UE) comprising at least a first Subscriber Identity Module (SIM) and a second SIM, the network node comprising a controller and a transceiver, wherein the controller is configured to: send, to said UE, a first token (T_{A}) derived from a seed token (T_{S}) using a first cryptographic key (K_{A}, K_{NASenc_A}) associated with the first SIM; and receive, from said UE, a second token (T_{B}) derived by the UE by decrypting said first token (T_{A}) using said first cryptographic key (K_{A}, K_{NASenc_A}) associated with the first SIM to derive the seed token (T_{S}) and by encrypting the derived seed token (T_{S}) using a second cryptographic key (K_{B}, K_{NASenc_B}) associated with the second SIM.

In one aspect, the invention provides a network node associated with a first mobile network operator (MNO) communicating with a user equipment (UE) comprising a first Subscriber Identity Module (SIM) associated with the first MNO and a second SIM associated with a second MNO, the network node comprising a controller and a transceiver, wherein the controller is configured to: perform a registration procedure with the UE using the first SIM; obtain information indicating that the UE includes said second SIM associated with the second MNO; and receive, from a node of said second MNO, information indicating whether or not the second SIM associated with the second MNO is blocked.

In one aspect, the invention provides a user equipment (UE) comprising at least a first Subscriber Identity Module (SIM) and a second SIM, the UE comprising: means for receiving, from a network node, at least a first token (T_{A}) derived from a seed token (T_{S}) using a first cryptographic key (K_{A}, K_{NASenc_A}) associated with the first SIM; means for deriving a first third order token (T_{AB}) by encrypting the received first token (T_{A}) using a second cryptographic key (Ks, K_{NAsenc_B}) associated with the second SIM; and means for sending said third order token (T_{AB}) to the network node.

In one aspect, the invention provides a network node communicating with a user equipment (UE) comprising at least a first Subscriber Identity Module (SIM) and a second SIM, the network node comprising: means for sending, to said UE, at least a first token (T_{A}) derived from a seed token (T_{S}) using a first cryptographic key (K_{A}, K_{NASenc_A}) associated with the first SIM; and means for receiving, from said UE, a first third order token (T_{AB}) derived by the UE by encrypting the first token (T_{A}) using a second cryptographic key (K_{B}, K_{NASenc_B}) associated with the second SIM.

In one aspect, the invention provides a user equipment (UE) comprising at least a first Subscriber Identity Module (SIM) and a second SIM, the UE comprising: means for receiving, from a network node, a first token (T_{A}) derived from a seed token (T_{S}) using a first cryptographic key (K_{A}, K_{NAsenc_A}) associated with the first SIM; means for decrypting said first token (T_{A}) using said first cryptographic key (K_{A}, K_{NASenc_A}) associated with the first SIM to derive the seed token (T_{S}); and means for deriving a second token (T_{B}) by encrypting the derived seed token (T_{S}) using a second cryptographic key (K_{B}, K_{NASenc_B}) associated with the second SIM; and means for sending said second token (T_{B}) to the network node.

In one aspect, the invention provides a network node communicating with a user equipment (UE) comprising at least a first Subscriber Identity Module (SIM) and a second SIM, the network node comprising: means for sending, to said UE, a first token (T_{A}) derived from a seed token (T_{S}) using a first cryptographic key (K_{A}, K_{NASenc_A}) associated with the first SIM; and means for receiving, from said UE, a second token (T_{B}) derived by the UE by decrypting said first token (T_{A}) using said first cryptographic key (K_{A}, K_{NASenc_A}) associated with the first SIM to derive the seed token (T_{S}) and by encrypting the derived seed token (T_{S}) using a second cryptographic key (K_{B}, K_{NAsenc_B}) associated with the second SIM.

In one aspect, the invention provides a network node associated with a first mobile network operator (MNO) communicating with a user equipment (UE) comprising a first Subscriber Identity Module (SIM) associated with the first MNO and a second SIM associated with a second MNO, the network node comprising: means for performing a registration procedure with the UE using the first SIM; means for obtaining information indicating that the UE includes said second SIM associated with the second MNO; and means for receiving, from a node of said second MNO, information indicating whether or not the second SIM associated with the second MNO is blocked.

Aspects of the invention extend to corresponding systems and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF THE DRAWINGS

Embodiments of the invention will now be described, by way of example, with reference to the accompanying drawings in which:

FIG. 1 illustrates schematically a generic mobile (cellular or wireless) telecommunication system to which embodiments of the invention may be applied;

FIGS. 2 and 3 are schematic block diagrams of a mobile device (user equipment) forming part of the system shown in FIG. 1;

FIG. 4 is a schematic block diagram of a base station apparatus forming part of the system shown in FIG. 1;

FIG. 5 is a schematic block diagram of a core network node forming part of the system shown in FIG. 1;

FIGS. 6 to 9 and 13 to 15 illustrate schematically some exemplary ways in which embodiments of the present invention may be implemented in the system shown in FIG. 1;

FIG. 10 illustrates schematically a token generation function in accordance with an embodiment of the present invention;

FIG. 11 illustrates schematically some exemplary types of associations between USIMs and corresponding (hardware) components of the mobile device shown in FIGS. 2 and 3; and

FIG. 12 illustrates an exemplary mapping table for USIM and hardware association.

### DESCRIPTION OF THE EMBODIMENTS

Overview Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

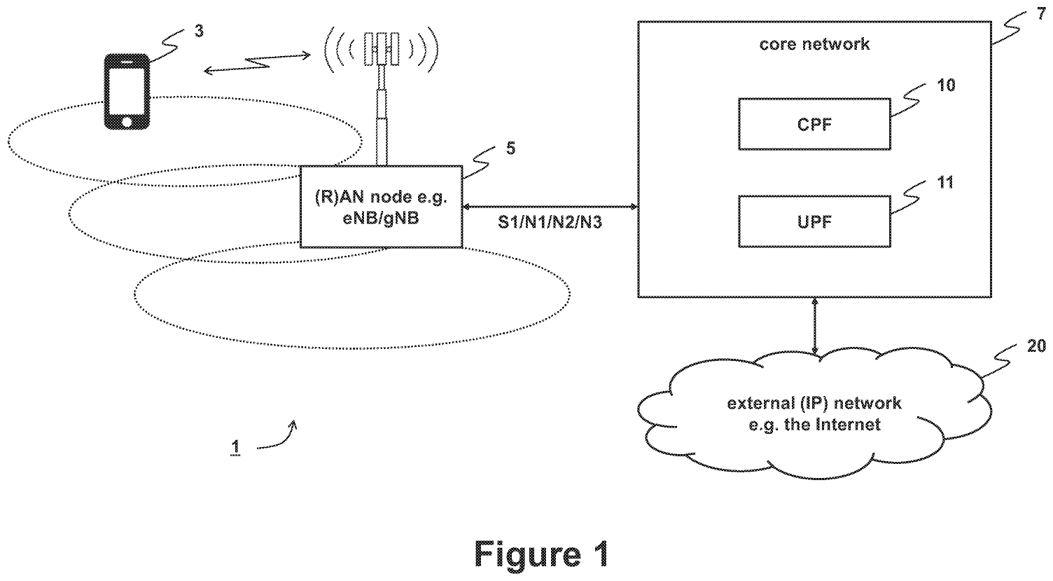

Although for efficiency of understanding for those of skill in the art, the invention will be described in detail in the context of a 3GPP system (a 5G network), the principles of the invention can be applied to other systems in which slice scheduling is performed. FIG. 1 illustrates schematically a mobile (cellular or wireless) telecommunication system 1a to which embodiments of the invention (‘solution variants’) may be applied.

In this network, users of mobile devices 3 (UEs) can communicate with each other and other users via respective base stations 5 and a core network (CN) 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 are shown in FIG. 1 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘eNB’ and a base station 5 that supports NextGeneration/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N1’, ‘N2’, ‘N3’ interface, and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) 10 and user plane functions (UPFs) 11. A so-called Home Subscriber Server (HSS) 15 is also provided in (or coupled to) the core network 7. Effectively, the HSS 15 is a database that contains user-related and subscriber-related information. The HSS 15 also provides support for mobility management, call and session setup, user authentication, and access authorisation.

From the core network 7, connection to an external IP network 20 (such as the Internet) is also provided (e.g. via a gateway).

In this example, the mobile device 3 is a multi-SIM device which supports two USIMs (although it will be appreciated that the mobile device 3 may also support three or more USIMs, if appropriate).

Beneficially, the components of this system 1 are configured to verify whether a particular mobile device 3 supports (uses) multiple USIMs, and to identify unequivocally the identities of the subscription information associated with these USIMs.

In more detail, in one embodiment, verification of the USIMs in the UE 3 is carried out using the permanent keys associated with the USIMs. In this case, the UE 3 and the network (an appropriate node of the core network 7) perform a cryptographic operation using subscription-unique information to establish that the USIMs in the multi-SIM device are indeed in the device. This involves cross-application of the unique permanent keys from multiple USIMs in a series of cryptographic operations in order to generate a transformed value as a way to fuse elements of multiple subscription information together. Beneficially, such cryptographic operation using the unique keys from multiple subscriptions assures that the cryptographically transformed value is uniquely derived from the specific USIMs and that the USIMs are in the UE 3.

In another embodiment, verification of the USIMs in the UE 3 is carried out using dynamically created keys (instead of the permanent keys). In this case, the UE 3 and the network perform an appropriate cryptographic operation using dynamically-created security context associated with the subscriptions associated with USIMs (after the subscriptions are fully authenticated) in order to determine whether the USIMs are indeed in the UE 3.

In another embodiment, verification of the USIMs in the UE 3 is carried out over multiple NAS connections. In this case, the UE 3 and the network perform an appropriate cryptographic operation using the NAS security context of the subscription (after the subscription associated with the USIM is fully authenticated) in order to determine whether the specific USIMs are indeed in the UE 3.

In yet another embodiment, verification of the USIMs in the UE 3 is carried out based on exchanging USIM information between different MNOs (e.g. the MNOs associated with the USIM(s) in the UE 3/USIM(s) previously used by the UE 3). Specifically, when an MNO obtains subscriber information of the USIM associated with that MNO and another USIM, the MNO sends its subscriber information, such as IMSI, IMEI, and operator-specific status information to the MNO that the other USIM is a subscriber of. The operator-specific status information may include, for example, information identifying whether the subscriber is barred from service and/or the like. The exchange and sharing of subscriber information between the MNOs allows the MNOs to apply the same handling to the user of these subscriptions, such as termination of any ongoing call, or blocking/unblocking of service.

The components of the system 1 may also be configured to perform re-verification (e.g. UE initiated or timer based) of the USIM association, when appropriate. In this case, re-verification may be initiated by the UE 3 when the UE 3 detects a change of at least one USIM. When the UE 3 indicates a change of USIM to the network, the UE 3 and the network proceed to perform an appropriate procedure (e.g. one of the procedures described above) to re-verify the USIM association and update any mapping information held in the network. Alternatively, or additionally, the USIM association may have an associated validity period and re-verification of the USIM association may be performed upon expiry of the validity period (which may be determined using a timer and/or the like).

User Equipment (UE)

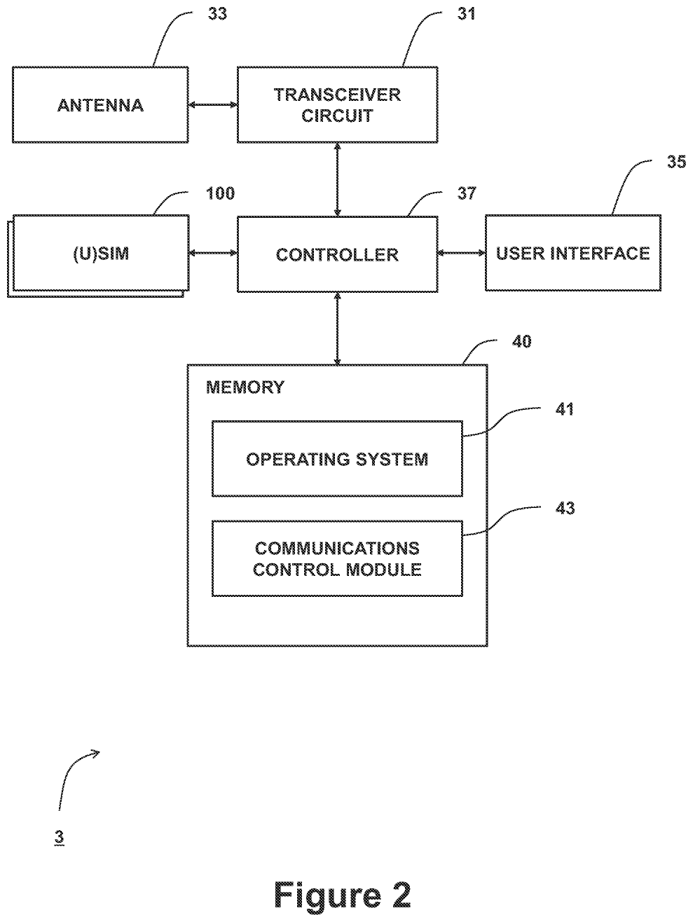

FIG. 2 is a block diagram illustrating, in more detail, the main components of the UE (mobile device 3) shown in FIG. 1. As shown, the UE 3 includes a transceiver circuit 31 which is operable to transmit signals to and to receive signals from the connected node(s) via one or more antenna 33. Although not necessarily shown, the UE 3 will of course have all the usual functionality of a conventional mobile device (such as a user interface 35) and this may be provided by any one or any combination of hardware, software and firmware, as appropriate. A controller 37 controls the operation of the UE in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signaling messages and uplink/downlink data packets between the UE 3 and other nodes, including (R)AN nodes 5 and core network nodes.

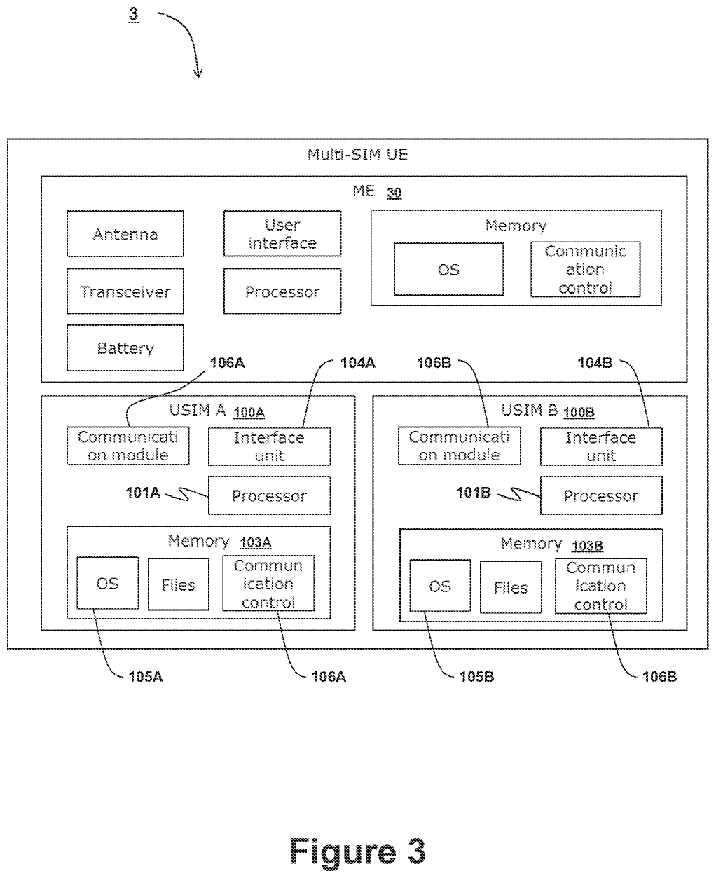

The UE 3 may comprise a multi-SIM device in which case it may be equipped with one or more transceiver circuits 31, depending on hardware implementation. When present, such multiple transceiver circuits 31 enable simultaneous connection using multiple SIMs. Further details of an exemplary multi-SIM capable UE 3 are shown in FIG. 3. In this example, two USIMs 100A and 100B are shown.

The term “UE” refers to the mobile phone in general, which includes at least the following components:
Mobile Equipment (ME) 30: the ME 30 is the “mobile phone” as the hardware device. It includes at least one processor (controller 37), memory unit 40, antenna 33, transceiver unit 31, user interface 35 (such as screen, buttons, cable socket), battery unit, etc., as described with reference to FIG. 2 above.
Subscriber Identity Module (SIM) or Universal Subscriber Identity Module (USIM) 100: the SIM or USIM is an application that runs in the UICC card. The UICC card is a small integrated circuit that includes an associated processor 101 (controller), a communication module 102, a memory unit 103, and an interface unit 104 to communicate with the ME part of the UE 3. The UICC is also called a “smart card”. The processor 101 controls the operation of the USIM 100 in accordance with software stored in the memory 103. The USIM software includes, among other things, an operating system (OS) 105, and a communications control module 106.

The term ‘SIM’ generally refers to the application in the UICC card that is used in 2G GSM mobile system. The term ‘USIM’ generally refers to the application in the UICC card that is used in 3G (UMTS), 4G (LTE), and 5G systems. In addition, ‘eSIM’ is a SIM functionality embedded in the ME 30 itself, rather than being provided using a physical (removable) UICC card. In most technical context, these terms are interchangeable, and the term ‘SIM’ is more generic. From the perspective of the present disclosure, the terms ‘SIM’, ‘USIM’, and ‘eSIM’ are used interchangeably. The SIM and USIM application and eSIM contain the credentials, such as the long term identifier (IMSI in 3GPP) and long term secret key.

In this disclosure, either ‘ME’, ‘mobile device’, or simply ‘device’ is used to refer to the same entity, namely the mobile handset in general for any generation of technology. In addition, ‘SIM’ or ‘USIM’ are used in this disclosure depending on the context. However, they generally refer to the applications that reside in the UICC.

(R)AN Node

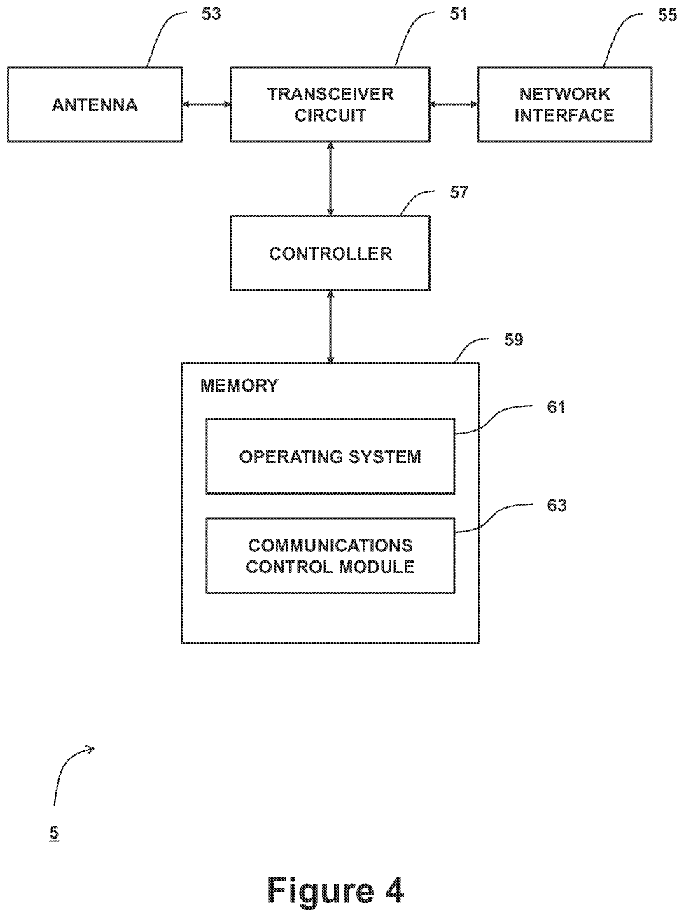

FIG. 4 is a block diagram illustrating, in more detail, the main components of an exemplary (R)AN node 5 (base station) shown in FIG. 1. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3 and the core network nodes/network elements.

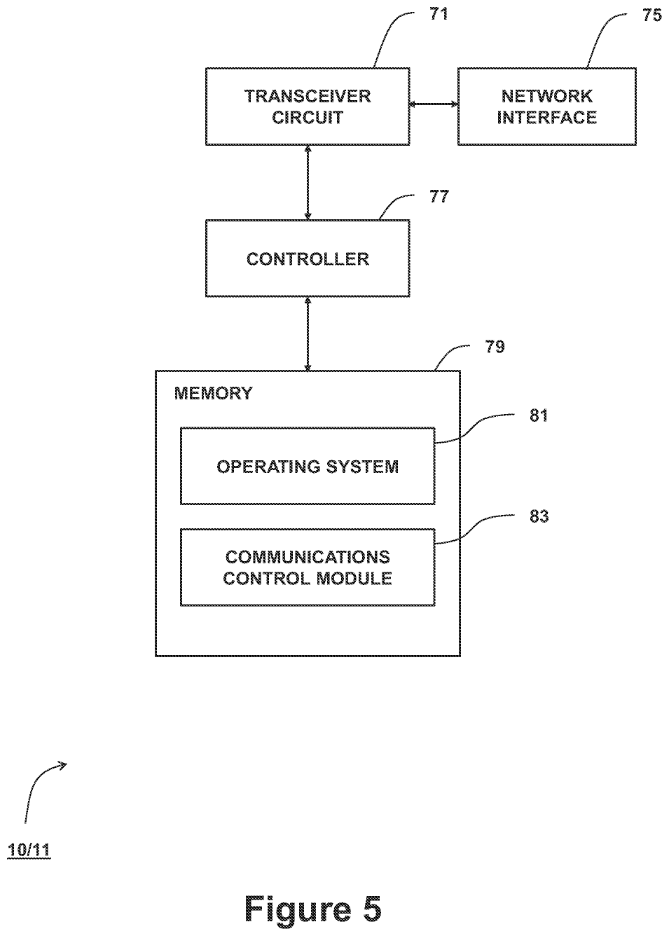

Core network node FIG. 5 is a block diagram illustrating, in more detail, the main components of a generic core network node (network element or function) shown in FIG. 1 (including the HSS 15 mentioned above). As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, (R)AN node 5, and other core network nodes. Such signaling includes appropriately formatted signalling messages in accordance with one of the following embodiments.

### DETAILED DESCRIPTION

Assumption/Trust Model

For the purpose of this disclosure, the following assumptions apply:
In the most stringent case, all entities except for the USIM 100 and the HSS 15 may possibly be compromised and may act maliciously. In other words, in the most stringent case, only the USIM 100 and the HSS 15 can be trusted. This applies to solution 1 variant 1.
In a less stringent case, the USIM 100, the ME 30, (nodes of) the CN 7, and the HSS 15 are trusted. This applies to solution 1 variant 2 through variant 5. In this case, intermediate entities such as the RAN node 5 or any other 3^{rd} party entity (e.g. eavesdropper) may alter or replay messages between the UE 3 and the network.
The multi-SIM capable ME 30 is trusted to indicates its capability and presence of multiple SIMs when they are present. In other words, the multi-SIM capable ME 30 does not indicate it is only a single-SIM capable device.
The USIMs 100 in the multi-SIM capable UE 3 has a respective subscription from 1) either the same MNO or 2) different MNOs (which may have a business relationship, e.g. roaming partner operators in different countries or a multi-national operator that operates in multiple countries). In this case, it is assumed that there is an appropriate communication link between the two operators' network. Both scenarios 1) and 2) are applicable to any solution 1 variants and any solution 2 variants.
A potential attacker may be capable of taking any of the following actions: 1) passively monitor the encrypted or unencrypted messages; 2) alter the content of messages; 3) replay messages that were sent in the past; and 4) drop messages. However, the attacker does not have access to: 1) permanent key stored in the USIM 100; 2) dynamically generated keys as the result of a successful attach procedure; and 3) the cryptographic operation performed in the USIM 100, ME 30, CN 7, and/or HSS 15.

Solution 1: Verification of the USNs in the ME

This solution (embodiment) aims to address the issue of identification of USIMs inserted in a multi-SIM capable mobile device. The following is a detailed description of this solution and some possible variants thereof.

Solution 1, Variant 1: Verification of the USIMs in the ME Using Permanent Keys

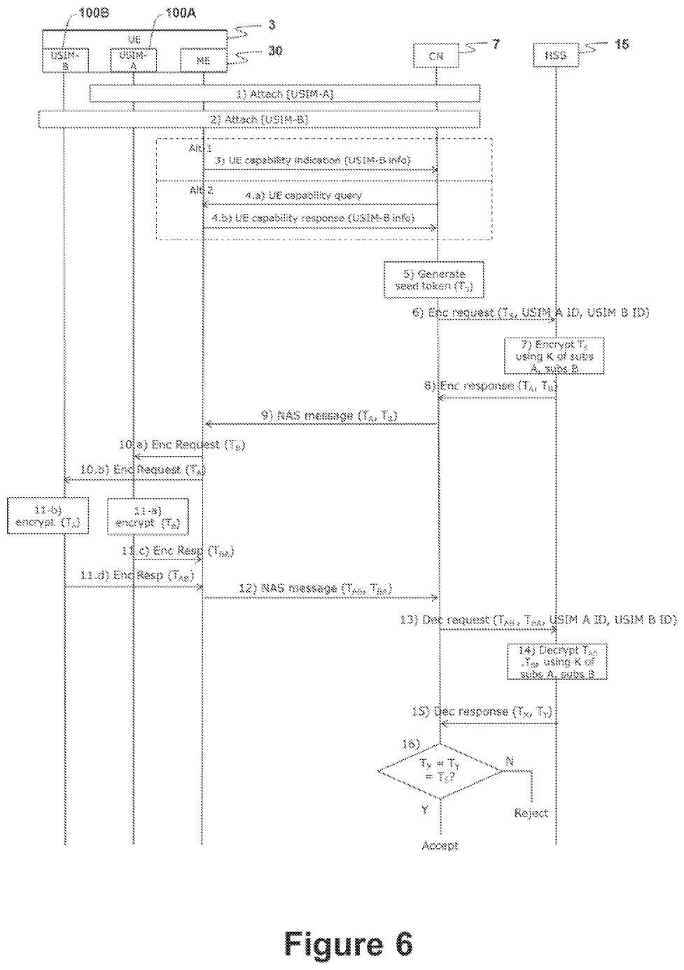

An exemplary procedure for the CN 7 to verify the UE's 3 (ME's 30) multi-SIM capability and identify subscriber information associated with the USIMs 100 inserted in the ME 30 is illustrated in FIG. 6.

1. In the first step of this procedure, the UE 3 attaches to the core network using one of the subscriptions associated with one of the USIMs 100 in it according to the defined 3GPP procedure, such as in TS 23.401 [1] or TS 23.502 [3]. In this figure, the UE 3 is attached to the network using the subscription associated with USIM 100A (‘USIM-A’) as an example. As the result of this step, the UE 3 as a whole (including both the ME 30 and the subscription associated with USIM-A 100A) is fully authenticated by the network.

2. Next, the UE 3 attaches to the network using another subscription associated with another USIM 100 in it according to applicable 3GPP procedures. In this example, the UE 3 is attached to the network using the subscription associated with USIM-B 100B as an example. As a result of this step, the UE 3 as a whole (including both the ME 30 and the subscription associated with USIM-B 100B) is fully authenticated by the network.

3. [Alternative procedure 1] The UE 3 reports to the CN 7 (AMF, for example) that it has another USIM 100 (because the ME 30 is a multi-SIM capable device) by sending an appropriately formatted ‘UE Capability Information’ message, for example. In the example shown in the figure above, the UE 3 communicates using the first USIM's 100A subscription. At this time, the UE 3 provides the second USIM's 100B subscription information, e.g. the IMSI of USIM-8 100B. Alternatively, the UE 3 may communicate using the second USIM's 100B subscription and provide the first USIM's 100A subscription information.

4. [Alternative procedure 2] Alternative to step 3, the CN 7 (AMF, for example) queries the UE 3 regarding the UE's multi-SIM capability by sending an appropriately formatted ‘UE Capability Query’ message, for example. The UE 3 responds to the CN 7 by sending an appropriate ‘UE Capability Response’ message, for example. In the example shown in FIG. 6, the UE 3 communicates using the first USIM's 100A subscription. At this time, the UE 3 provides the second USIM's 100B subscription information, e.g. the IMSI of USIM-B 100B. Alternatively, the UE 3 may communicate using the second USIM's 100B subscription, and provide the first USIM's 100A subscription information, e.g. the IMSI of USIM-A 100A.

It should be noted that, if appropriate, either one of the alternative procedures described in steps 3 and 4 may be performed as part of the attach procedure (steps 1 and 2).

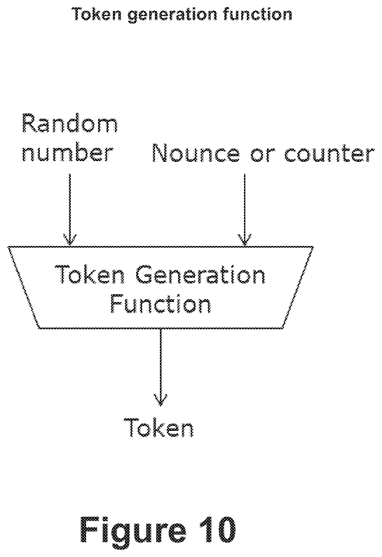

5. The CN 7 (AMF, for example) generates a seed token (T_{S}) using a Token Generation Function (TGF). An exemplary Token Generation Function is shown in FIG. 10.

6. The CN 7 (AMF, for example) requests the server for subscription data (e.g. HSS 15, HLR or UDM, and so on) to transform the seed token by sending an ‘Encryption request’ message, for example. In the exemplary message shown in this figure, the CN 7 sends the seed token (T_{S}), and identities of both USIM-A 100A and USIM-8 100B. The identity of these two USIMs 100A, 100B may comprise for example an IMSI and/or the like.

7. The server for subscription data (UDM, for example) looks up the subscription database for the subscribers corresponding to both USIM-A 100A and USIM-B 100B, and locates the permanent keys for these subscribers. In one example, using the permanent key for these subscribers, the server for subscription data encrypts the seed token (T_{S}), and generates a pair of 2_{nd} order tokens (T_{A} and T_{B}).

In this example, the 2_{rd} order token generation function is implemented using the following formulas:

T_{A}=Enc(T_{S},K_{A})

T_{B}=Enc(T_{S},K_{B})

, where
T_{S}: seed token;
T_{A}: seed token (T_{S}) encrypted by using the permanent key ‘K’ for subscriber A corresponding to USIM-A 100A (K_{A});
T_{B}: seed token (T_{S}) encrypted by using the permanent key ‘K’ for subscriber B corresponding to USIM-B 100B (K_{B});
K_{A}: permanent key‘K’ for subscriber A, corresponding to USIM-A 100A;
K_{B}: permanent key‘K’ for subscriber B, corresponding to USIM-8 100B; and
Enc(x,y): encryption function to encrypt ‘x’ with key ‘y’.

It will be appreciated that other suitable formulas/token generation functions may also be used.

8. The server for subscription data returns the pair of 2_{nd} order tokens (T_{A} and T_{B}) to the CN 7 (AMF, for example) e.g. by sending an appropriately formatted ‘Encryption response’ message.

9. The CN 7 (AMF, for example) sends the pair of 2_{nd} order tokens (T_{A} and T_{B}) to the UE 3 e.g. by sending an appropriate NAS message.

10. The ME 30 part of the UE 3 requests the first USIM 100A to transform the received token (T_{B}), and requests the USIM-8 100B to transform the received token (T_{A}) e.g. by sending respective ‘Encryption request’ messages to the USIMs 100A, 100B. It should be noted here that the token transformed by the server for subscription data using subscription B's permanent key (K_{B}) is sent to the USIM-A 100A. Similarly, the token transformed by the server for subscription data using subscription A's permanent key (K_{A}) is sent to the USIM-B 100B. Beneficially, this ‘swapping operation’ allows the UE 3 (ME 30 and USIMs 100A/100B collectively) to generate a set of 3^{rd} order tokens that are generated using two permanent keys in two different order.

11. In one example, the first USIM 100A encrypts the received token (T_{B}) using its own permanent key ‘K’ (K_{A}) stored in USIM-A 100A. Similarly, the second USIM 100B encrypts the received token (T_{A}) using its permanent key ‘K’ (K_{B}) stored in USIM-8 100B. Then both USIM-A 100A and USIM-8 100B provide the generated 3^{rd} order token to the ME 30 by sending an appropriately formatted ‘Encryption response’ message, for example.

In this example, the 3^{rd} order token generation function is implemented using the following formulas:

T_{BA}=Enc(T_{B},K_{A})

T_{AB}=Enc(T_{A},K_{B})

, where
T_{BA}: the 3_{rd} order token encrypted by using the permanent key ‘K’ stored in USIM-A 100A (K_{A});
T_{AB}: the 3_{rd} order token encrypted by using the permanent key ‘K’ stored in USIM-B 1008 (Ks); and
T_{A}, T_{B}, K_{A}, K_{B}, Enc(x,y): as described in step 7 above.

It will be appreciated that other suitable formulas/token generation functions may also be used.

12. The ME 30 sends the pair of 3^{rd} order tokens (T_{AB}, T_{BA}) to the CN 7 (AMF, for example) using e.g. an appropriate NAS message (sent via the base station 5).

13. The CN 7 (AMF, for example) requests the server for subscription data (UDM, for example) to de-transform the pair of 3^{rd} order tokens (T_{AB}, T_{BA}) back to the 1ₛₜ order token. In one example, the CN 7 conveys the 3^{rd} order token pair to the subscription data server along with the identity of USIM-A 100A and USIM-B 100B in a specific order so that the subscription data server can unambiguously identify the sequence the de-transformation is to be carried out (for example, as discussed in step 14 below).

14. The server for subscription data (UDM, for example) de-transforms the received pair of 3^{rd} order tokens (T_{AB}, T_{BA}). In one example, the server for subscription data decrypts the 3^{rd} order token back to 2^{rd} order token, then use this 2^{nd} order token as input and decrypts it to yield the 1^{st} order token.

In this example, the de-generation function is implemented using the following formulas:

T_{X}=Dec(Dec(T_{AB},K_{B}),K_{A})

T_{Y}=Dec(Dec(T_{BA},K_{A}),K_{B})

, where
T_{X}: the de-transformed 3^{rd} order token for subscriber A;
T_{Y}: the de-transformed 3^{rd} order token for subscriber B;
T_{AB}, T_{BA}: as described in step 11 above;
T_{A}, T_{B}, K_{A}, K_{B}: as described in step 7 above; and
Dec (x,y): decryption function to decrypt ‘x’ with key ‘y’.

It should be noted that the order of transformation in the earlier steps are un-done in the exact reverse order. In any case, it will be appreciated that other suitable formulas/de-generation functions may also be used.

15. The server for subscription data (UDM, for example) returns the de-transformed 1^{st} order token (T_{X}, T_{Y}) to the CN 7 (AMF, for example).

16. The CN 7 (AMF, for example) checks if (T_{X}=T_{Y}=T_{S}) is true or not. If true, the CN 7 accepts the result and acknowledge that the first USIM 100A and the second USIM 100B are indeed in the same ME 30. Otherwise, the CN 7 considers the USIM information previously provided by the UE 3 in step 3 and 4 does not accurately reflect the actual USIMs 100 in the ME 30.

Solution 1, Variant 2: Verifying USIMs in the ME Using Dynamically Created Keys

As an alternative to Solution 1 variant 1, the following mechanism uses dynamically created cryptographic keys instead of permanent keys.

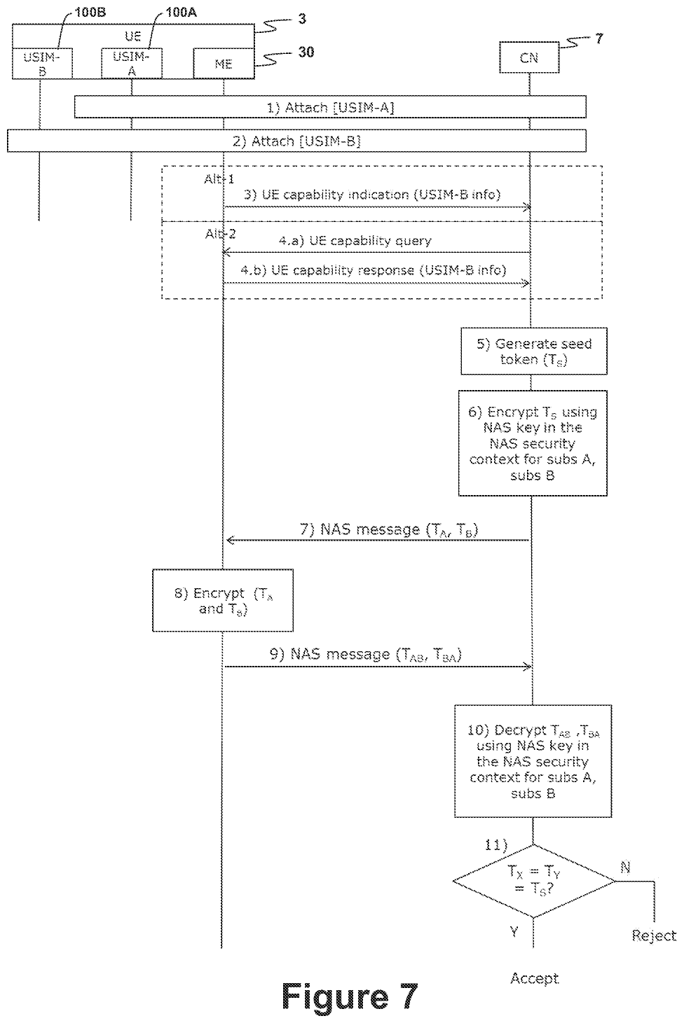

An exemplary procedure in accordance with this variant is illustrated in FIG. 7.

1. The UE attaches to the core network using one of the subscriptions associated with one of the USIMs 100 in it according to the defined 3GPP procedure, such as in TS 23.401 [1] or TS 23.502 [3]. In this figure, the UE 3 is attached to the network using the first USIM's 100A subscription as an example. At this time, the UE 3 as a whole (including both the ME 30 and the subscription in USIM-A 100A) is fully authenticated by the network, and NAS security context is established in the CN 7 (AMF, for example) and the UE 3 for this subscription. The security context includes information such as the NAS ciphering algorithm, NAS integrity protection algorithm, NAS confidentiality protection (ciphering) key, NAS integrity protection key, etc.

2. The UE 3 also attaches to the network using another subscription associated with another USIM 100 in it according to the defined 3GPP procedure. In this figure, the UE 3 is attached to the network using USIM-B's 100B subscription as an example. At this time, the UE 3 as a whole (including both the ME 30 and the subscription in USIM-B 100B) is fully authenticated by the network, and NAS security context is established in the CN 7 (AMF, for example) and the UE 3 for this subscription. The security context includes information such as the NAS ciphering algorithm, NAS integrity protection algorithm, NAS confidentiality protection (ciphering) key, NAS integrity protection key, etc. 3. [Alternative procedure 1] The UE 3 reports to the CN 7 (AMF, for example) that it has another USIM (because the ME 30 is a multi-SIM capable device) by sending an appropriately formatted ‘UE Capability Information’ message and/or the like. In the example shown in FIG. 7, the UE 3 communicates using the first USIM's 100A subscription. At this time, the UE 3 provides the second USIM's 100B subscription information, e.g. the IMSI of USIM-8 100B.

Alternatively, the UE 3 may communicate using the second USIM's 100B subscription and provide the first USIM's 100A subscription information. 4. [Alternative procedure 2] Alternative to step 3, the CN 7 (AMF, for example) queries the UE 3 regarding the UE's multi-SIM capability by sending an appropriate message, e.g. a ‘UE Capability Query’ message. The UE 3 responds to the CN 7 by sending an appropriately formatted ‘UE Capability Response’ message and/or the like. In the example shown in FIG. 7, the UE 3 communicates using the first USIM's 100A subscription. At this time, the UE 3 provides the second USIM's 100B subscription information, e.g. the IMSI of USIM-B 100B. Alternatively, the UE 3 may communicate using the second USIM's 100B subscription, and provide the first USIM's 100A subscription information, e.g. the IMSI of USIM-A 100A.

It should be noted that the alternative procedures in step 3 and 4 above may be performed as part of the attach procedure (in steps 1 and 2).

5. The CN 7 (AMF, for example) generates a seed token (T_{S}) using an appropriate Token Generation Function (TGF), e.g. using the Token Generation Function shown in FIG. 10.

6. The CN 7 (AMF, for example) looks up the NAS security context corresponding to the first USIM 100A and the second USIM 100B, and locates the NAS ciphering keys for these subscribers. In one example, using the NAS ciphering key for these subscribers, the CN 7 encrypts the seed token (T_{S}), and generates a pair of 2^{rd} order tokens (T_{A} and T_{B}).

In this example, the 2^{rd} order token generation function is implemented using the following formulas:

T_{A}=Enc(T_{S},K_{NASenc_A})

T_{B}=Enc(T_{S},K_{NASenc_B})

, where
T_{S}: seed token;
T_{A}: seed token (T_{S}) encrypted by using the derived NAS security context for subscriber A corresponding to USIM-A 100A (for example, K_{NASsenc_A});
T_{B}: seed token (T_{S}) encrypted by using the derived NAS security context for subscriber B corresponding to USIM-B 100B (for example, K_{NASenc_B});
K_{NASenc_A}: derived NAS security context for subscriber A, corresponding to USIM-A 100A; and
K_{NAsenc_B}: derived NAS security context for subscriber B, corresponding to USIM-B 100B.

It will be appreciated that other suitable formulas/token generation functions may also be used.

7. The CN 7 (AMF, for example) sends the pair of 2^{nd} order tokens (T_{A} and T_{B}) to the UE 3 by sending a NAS message, for example.

8. The ME 30 part of the UE 3 transforms the received 2^{nd} order tokens (T_{A} and T_{B}) and generates a 3^{rd} order token. It should be noted here that the ME 30 transforms the 2^{nd} order token that is generated by the CN 7 (AMF, for example) using subscription B's derived NAS security context key (for example, K_{NASenc_B}) in step 6, using subscription A's derived NAS security context key (for example, K_{NASsenc_A}). Similarly, the ME 30 transforms the 2^{nd} order token that is generated by the CN using subscription A's derived NAS security context key (for example, K_{NASenc_A}) in step 6, using subscription B's derived NAS security context key (for example, K_{NASenc_B}). This ‘swapping operation’ allows the ME 30 to generate a set of 3^{rd} order tokens that are generated using two derived NAS security context keys in two different order.

In this example, the 3^{rd} order token generation function is implemented using the following formulas:

T_{BA}=Enc(T_{B},K_{NASenc_A})

T_{AB}=Enc(T_{A},K_{NASenc_B})

, where
T_{BA}: the 3^{rd} order token encrypted by using the derived NAS security context for USIM-A 100A (for example, K_{NASenc_A});
T_{AB}: the 3^{rd} order token encrypted by using the derived NAS security context for USIM-B 100B (for example, K_{NASenc_B});
T_{A}, T_{B}, Enc(x,y): as described in step 7 of the first variant; and
K_{NASenc_A}, K_{NASenc_B}: as described in step 6 above.

9. The ME 30 sends the pair of 3^{rd} order token (T_{AB}, T_{BA}) to the CN 7 (AMF, for example) by sending an appropriate NAS message, for example.

10. The CN 7 (AMF, for example) de-transforms the received pair of 3^{rd} order tokens (T_{AB}, T_{BA}). In one example, the CN 7 decrypts the 3^{rd} order token back to 2^{nd} order token, then uses this 2^{nd} order token as input and decrypts it to yield the 1^{st} order token. In this case, the CN 7 applies the de-transformation in the reverse order as was done in step 6 and 8.

In this example, the de-generation function is implemented using the following formulas:

T_{X}=Dec(Dec(T_{AB},K_{NASenc_B}),K_{NASenc_A})

T_{Y}=Dec(Dec(T^{BA},K_{NASenc_A}),K_{NASenc_B})

, where
T_{X}: the de-transformed 3^{rd} order token for subscriber A;
T_{Y}: the de-transformed 3^{rd} order token for subscriber B;
T_{AB}, T_{BA}: as described in step 11 of the first variant;
T_{A}, T_{B}: as described in step 7 of the first variant;
Dec (x,y): as described in step 14 of the first variant; and
K_{NASenc_A}, K_{NASenc_B}: as described in step 6 above.

11. The CN 7 (AMF, for example) checks if (T_{X}=T_{Y}=T_{S}) is true or not. If true, the CN 7 accepts the result and acknowledges that the first USIM 100A and the second USIM 100B are indeed in the same ME 30. Otherwise, the CN 7 considers the USIM information previously provided by the UE 3 in step 3 and 4 does not accurately reflect the actual USIMs 100 in the ME 30.

Solution 1, Variant 3: Verifying USIMs in the ME Using Dynamically Created Keys

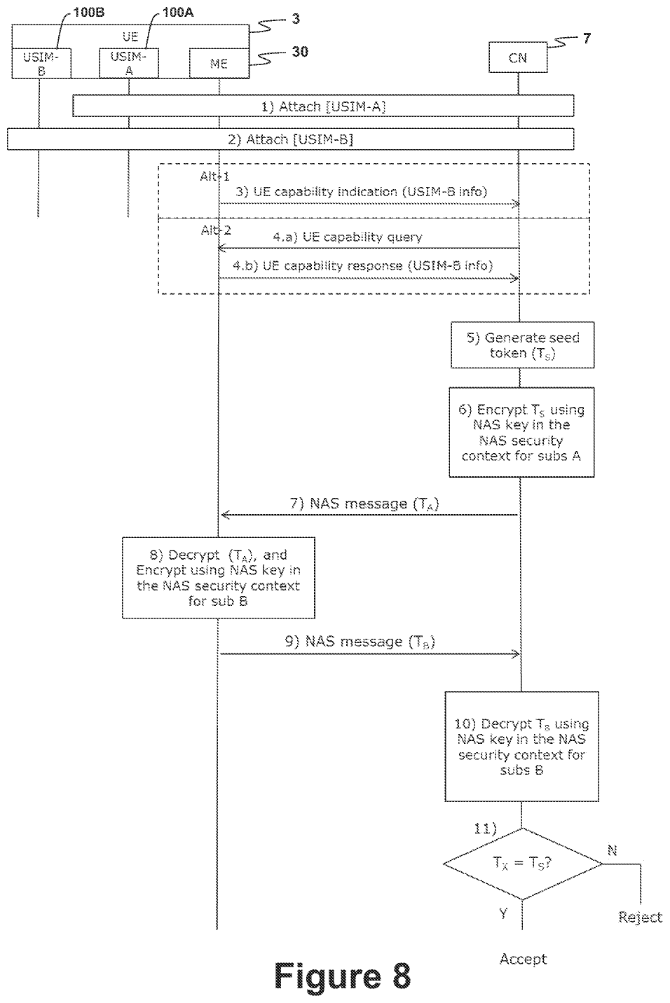

As an alternative to Solution 1 variant 1 and variant 2, the following mechanism uses a different cryptographic operation. FIG. 8 (which is a slightly modified procedure of the one shown FIG. 7) illustrates schematically an exemplary procedure in accordance with this solution variant.

An exemplary procedure in accordance with this variant is illustrated in FIG. 8.

1-5. These steps are the same as steps 1 to 5 described above with reference to FIG. 7.

6. The CN 7 (AMF, for example) looks up the NAS security context corresponding to one of the subscriptions, USIM-A 100A for example, and locates the NAS ciphering key for this subscriber. In one example, using the NAS ciphering key for USIM-A 100A, the CN 7 encrypts the seed token (T_{S}), and generates a 2^{nd} order token (T_{A}). For example, the 2^{nd} order token generation function may be implemented using the formulas shown in step 6 of the second variant.

7. The CN 7 (AMF, for example) sends the 2^{nd} order tokens (T_{A}) to the UE 3 by sending a NAS message, for example.

8. The ME 30 part of the UE 3 transforms the received 2^{nd} order token (T_{A}) and generates a 3^{rd} order token. In one example, the ME 30 first decrypts the received token (T_{A}) using the NAS ciphering key from subscriber A's derived NAS security context key (for example, K_{NASenc_A}).

Following this step, the ME 30 then encrypts the resulting value using the NAS ciphering key from subscriber B's derived NAS security context key (for example, K_{NASenc_B}).

In this example, the 3^{rd} order token generation is implemented using the following formula:

TB=Enc(Dec(T_{A},K_{NASenc_A}),K_{NASenc_B})

, where
T_{A}, T_{B}, Enc(x,y): as described in step 7 of variant 1;
Dec(x,y) as described in step 14 of variant 1; and
K_{NAsenc_A}, K_{NASenc_B}: as described in step 6 of variant 2.

9. The ME 30 sends the 3^{rd} order token (T_{B}) to the CN 7 (AMF, for example) using e.g. an appropriately formatted NAS message (sent via the base station 5).

10. The CN 7 (AMF, for example) de-transforms the received pair of 3^{rd} order tokens (T_{B}). In one example, the CN 7 decrypts the 3^{rd} order token using subscriber B's NAS ciphering key. In this example, the de-generation function is implemented using the following formula:

T_{X}=Dec(T_{B},K_{NASenc_B})

, where
T_{B}: as described in step 7 of variant 1; as shown in FIG. 6
K_{NASenc_B}: as described in step 6 of variant 2; and
T_{X}: as described in step 10 of variant 2.

11. The CN 7 (AMF, for example) checks if (T_{X}=Ts) is true or not. If true, the CN 7 accepts the result and acknowledge that the first USIM 100A and the second USIM 100B are indeed in the same ME 30. Otherwise, the CN 7 considers the USIM information previously provided by the UE 3 in step 3 and 4 does not accurately reflect the actual USIMs 100 in the ME 30.

Solution 1, Variant 4: Verifying USIMs in the ME Over Multiple NAS Connections

As an alternative to Solution1 variant 1 through 3, the following mechanism uses multiple NAS connections. In this solution variant, transformed tokens are sent between the CN 7 (AMF, for example) and the UE 3 over multiple NAS connections associated with multiple subscriptions.

In this solution variant, as an example, all steps except steps 7, 9, and 10 are the same as the corresponding steps of Solution 1, variant 2 (shown in FIG. 7).

1-6. The same as steps 1 to 6 described above with reference to FIG. 7.

7. The CN 7 (AMF, for example) sends the 2^{nd} order tokens (T_{A} and T_{B}) to the UE 3 by sending a NAS message over the connection associated with one of the subscriptions, for example the first USIM 100A.

8. The same as step 8 described above with reference to FIG. 7.

9. The ME 30 sends the pair of 3^{rd} order tokens (T_{AB}, T_{BA}) to the CN 7 (AMF, for example) by sending a NAS message over the connection associated with the subscription different from the one used in step 7, for example connection using the subscription of USIM-B 100B.

10. The CN 7 (AMF, for example) receives the pair of 3^{rd} order tokens (T_{AB}, T_{BA}) sent over the NAS connections associated with a different subscription from the one sent in step 7, and de-transforms the received pair of 3^{rd} order tokens (T_{AB}, T_{BA}). In one example, the CN 7 decrypts the 3^{rd} order token back to a 2^{nd} order token, then uses this 2^{nd} order token as input and decrypts it to yield the 1^{st} order token. In this case, the CN 7 applies the de-transformation in the reverse order as was done in steps 6 and 8. In this example, the de-generation function is the same as described with reference to step 10 of variant 2 above.

Solution 1, Variant 5: Verifying USIMs in the ME Over Multiple NAS Connections

As an alternative to Solution 1 variants 1 through 4, the following mechanism uses multiple NAS connections. In this solution variant, transformed tokens are sent between the CN 7 (AMF, for example) and the UE 3 over multiple NAS connections associated with multiple subscriptions.

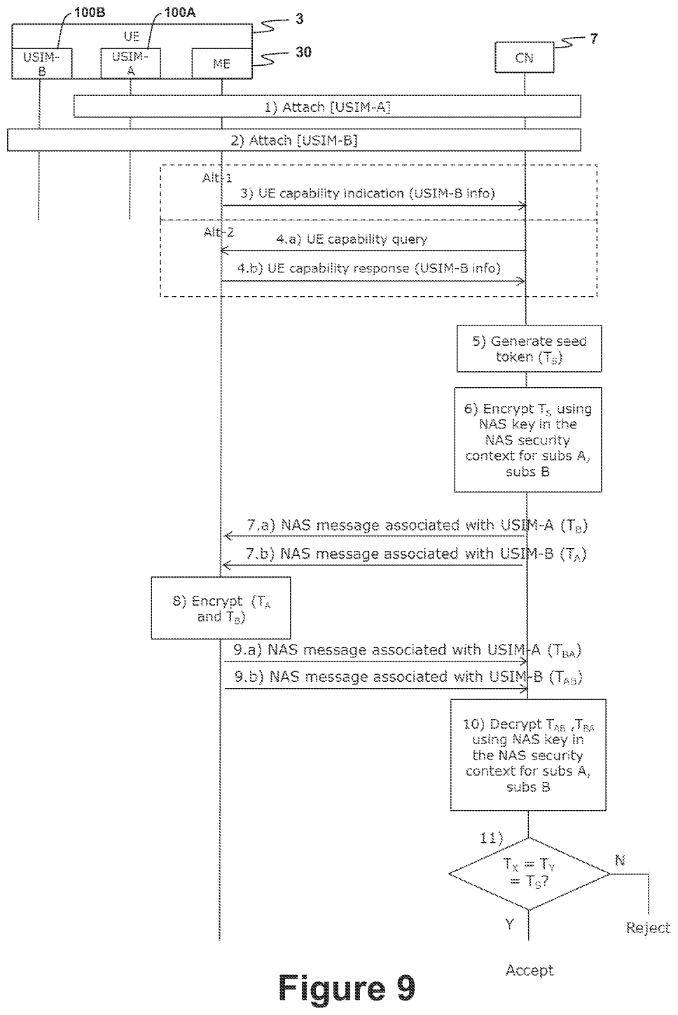

An exemplary procedure in accordance with this variant is illustrated in FIG. 9, which is based on FIG. 7 (variant 2) with slight modifications in steps 7, 9, and 10.

1-6. The same as steps 1 to 6 described above with reference to FIG. 7.

7. The CN 7 (AMF, for example) sends the 2^{nd} order token (T_{B}) to the UE 3 by sending a NAS message over the connection associated with one of the subscriptions, for example the first USIM 100A. Likewise, the CN 7 also sends the 2^{nd} order token (T_{A}) to the UE 3 by sending a NAS message over the connection associated with another subscription, for example the second USIM 100B. Therefore, the 2^{nd} order token generated by using a NAS key for subscription associated with USIM-A 100A is sent over the connection associated with USIM-B 100B. Similarly, the 2^{nd} order token generated by using a NAS key for subscription associated with USIM-B 100B is sent over the connection associated with USIM-A 100A.

8. The same as step 8 described above with reference to FIG. 7.

9. The ME 30 sends the 3^{rd} order token (T_{BA}) to the CN 7 (AMF, for example) by sending a NAS message over the connection associated with the subscription of the first USIM 100A. Similarly, the ME 30 sends the 3^{rd} order token (T_{AB}) to the CN 7 by sending a NAS message over the connection associated with the subscription of the second USIM 100B.

10. The CN 7 (AMF, for example) receives the pair of 3^{rd} order tokens (T_{AB}, T_{BA}) that are separately sent over different NAS connections associated with different subscriptions, for example USIM-A 100A and USIM-B 100B. The CN 7 de-transforms the received pair of 3^{rd} order tokens (T_{AB}, T_{BA}). In one example, the CN 7 decrypts the 3^{rd} order token back to the 2^{nd} order token, then uses this 2^{nd} order token as input and decrypts it to yield the 1^{st} order token. In this case, the CN 7 applies the de-transformation in the reverse order as was done in step 6 and 8. In this example, the de-generation function is the same as described with reference to step 10 of variant 2 above.

Token Generation Function

An exemplary Token Generation Function (TGF) is shown in FIG. 10.

In this example, the Token Generation Function uses multiple input parameters such as:
Random number: a number generated by a function such as random number generation (RNG) function. This parameter guarantees uniqueness of the generated token.
Nounce or counter: Nounce is a random number that is used only once, and counter is a monotonically increasing number. This parameter guarantees that the set of input parameters to generate a token is always unique, thus guarantees ‘freshness’ of the generated token, which prevents a replay attack.

Association Mapping in the Core Network

Using any of the methods described in variants of solution 1, the CN 7 (AMF, for example) is able to verify the multi-SIM devices and their subscription information. Using this information, the CN 7 is able to maintain a mapping table of the multi-SIM devices with the ME 30 hardware itself.

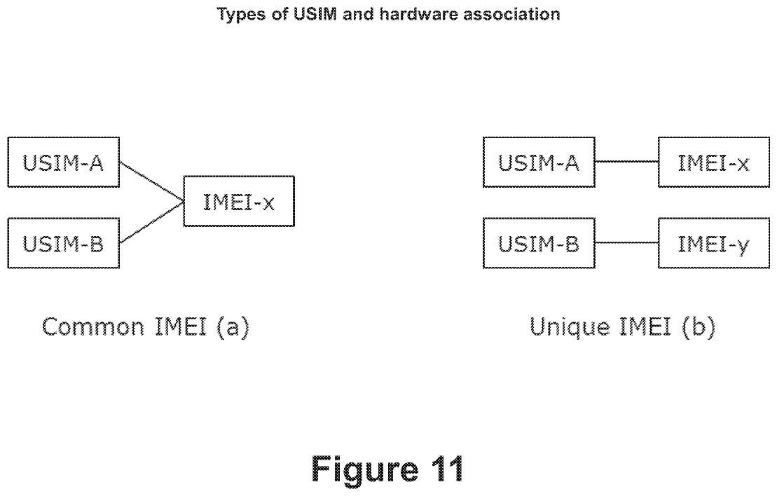

Depending on the ME implementation, the multi-SIM device 30 may have either a common or a unique IMEI for each USIM 100. IMEI is the identity of the device 30 as the hardware. This is illustrated in FIG. 11.

Specifically, the left hand side (a) of FIG. 11 shows the case where a single IMEI value is common to multiple USIMs 100 (in this example, one IMEI for both USIM-A 100A and USIM-B 100B). On the other hand, the right hand side (b) of FIG. 11 shows the case where a unique IMEI value is assigned to each USIM 100 (in this example, one IMEI for USIM-A 100A and a different IMEI for USIM-B 100B). In this case, it is possible that these IMEI values themselves do not indicate any correlation between them. Using the NAS procedure (Identification procedure consisting of Identity Request message and Identity Response message) as defined in TS 23.401 [1], TS 23.502 [3], TS 24.301 [4], or TS 24.501 [5], the CN 7 (AMF, for example) can query the identity of the UE 3 and retrieve the IMEI value(s) from the multi-SIM device. By combining the IMEI value query procedure and any of the methods described in solution 1 variants, the CN 7 is beneficially able to create a mapping between the USIM(s) 100 and the IMEI in the multi-SIM device 30.

In case the device hardware assigns separate unique IMEI value to each USIM 100, the CN 7 (AMF, for example) can trigger multiple identity query procedures to each USIM 100 to obtain all IMEI values in the device. Alternatively, the existing Identification procedure may be expanded so that the UE 3 provides all IMEI values that are assigned to the ME 30 in a single Identity Request and Response message exchange. These procedures establish the identity mapping between the USIM 100 and the IMEI. In addition, the methods described in solution 1 variants allow identification and verification of multiple USIMs 100 within a single device. By combining this information together, the CN 7 can establish the full identity mapping between the USIMs 100 and IMEI(s).

Alternatively, if the attach procedure (as shown in steps 1 and 2 of FIGS. 6, 7, 8, and 9) already includes the Identification procedure to obtain the IMEI from the device, then separate Identification procedure may not occur.

Using this mapping information, the set of IMEIs belonging to a single device can be identified to trigger actions in the network, such as blocking service to all subscriptions in a device due to reasons such as lost or stolen device.

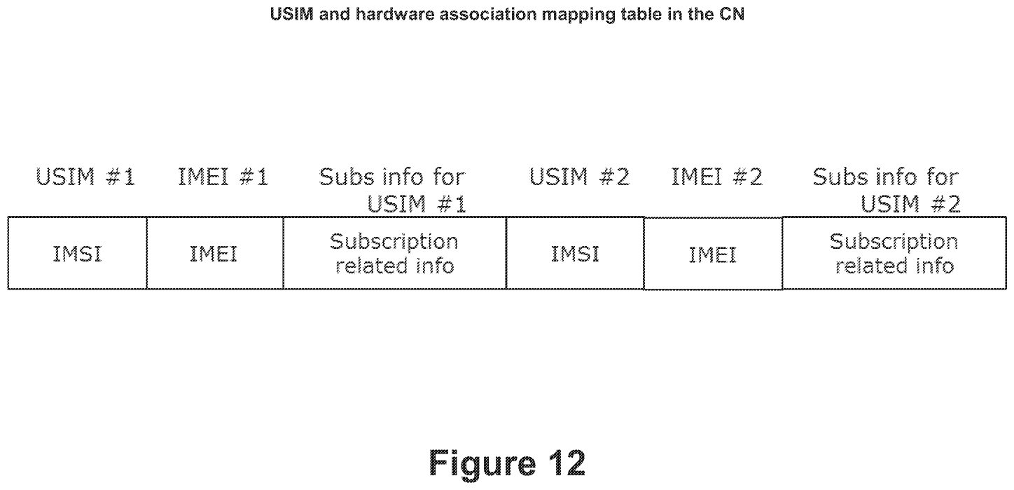

An example of the mapping table is shown in FIG. 12. This example shows the case where the multi-SIM device can hold up to two USIMs 100. It can be either separate physical UICC cards, multiple USIM applications in a single UICC, an embedded eSIM, or any combination thereof. If a single IMEI value is mapped to all USIM devices, such as the case in FIG. 11(a), then the value in IMEI #1 and IMEI #2 in FIG. 12 will be the same. If different IMEI values are assigned to the USIM devices, such as the case in FIG. 11(b), then the value in IMEI #1 and IMEI #2 hold different values, each one corresponds to the matching USIM 100.

Subscription related information for USIMs 100 contains, for example, administrative information such as whether the subscription associated with a USIM 100 is blocked or not.

What is shown in FIG. 12 is a conceptual representation of the mapping table. In one embodiment, it is possible that parts of the information are separately stored in multiple network elements but entities are logically correlated together. For example, IMEI values may be stored in the EIR while other information may be stored in different network element in the MNO.

Solution 2: Re-Verification of USIMs

This solution (embodiment) aims to address the issue of determining and re-verifying any change of USIMs in a multi-SIM capable mobile device.

The end user can replace the USIM 100 in either SIM slot in the ME 30 at any time. In other words, the USIM association that was previously established in the CN 7 (AMF, for example), as described in solution 1, can become obsolete at any time without the knowledge of the CN 7. Accordingly, solution 2 aims to provide a mechanism to ‘re-sync’ the USIM association in the CN 7 in such situations.

In older feature phones, the SIM slot was typically located behind the battery, thus removal of battery was necessary to replace the USIM card, implying that replacing the USIM cards necessarily require the ME 30 to go through a power cycle (i.e. re-initialization of the ME 30) and have the end user to enter the PIN code to activate the newly inserted USIM card.

However, in the more recent modem smartphones, a USIM card 100 can be removed and inserted without powering down the UE 3. When a new USIM 100 is inserted, the ME 30 queries the end user to enter the associated PIN number. If the correct PIN number is entered, the USIM 100 is activated in the ME 30. Therefore, the ME 30 itself does not necessarily go through a power cycle in modem smartphones.

The differences in ME 30 behaviour related to USIM replacement requires a solution for the CN 7 (AMF, for example) to detect and trigger re-verification of USIM association. In other words, when the previously established USIM association becomes no longer valid, the verification procedure (e.g. as described in solution 1 above) needs to be triggered again in order to keep the USIM association in the ME 30 up-to-date in the network.

The following is a detailed description of this solution and some possible variants thereof.

Solution 2, Variant 1: Re-Verification Based on UE Reporting

In this solution variant, the UE 3 reports a change of USIM pairings to the CN 7 (AMF, for example) whenever this event occurs. A change in USIM pairing may include any of the following scenarios: 1) a new USIM 100 is inserted to an empty slot; 2) a new USIM 100 replaces an existing USIM 100; 3) an existing USIM 100 is removed from a slot (leaving the slot empty); and 4) eSIM is re-programmed. When the ME 30 detects the presence of a USIM 100 in the slot or a change in the eSIM information, the ME 30 and the USIM 100 establish the communication as specified in 3GPP TS 31.101 [8] and TS 31.102 [9].

In scenarios 1), 2), and 4) in the previous paragraph, the insertion of a new USIM 100 or new information in the eSIM triggers an Attach procedure as described in 3GPP TS 23.401 [1] or TS 23.502 [3], for example. At this time, the UE 3 reports the CN 7 of the new association information.

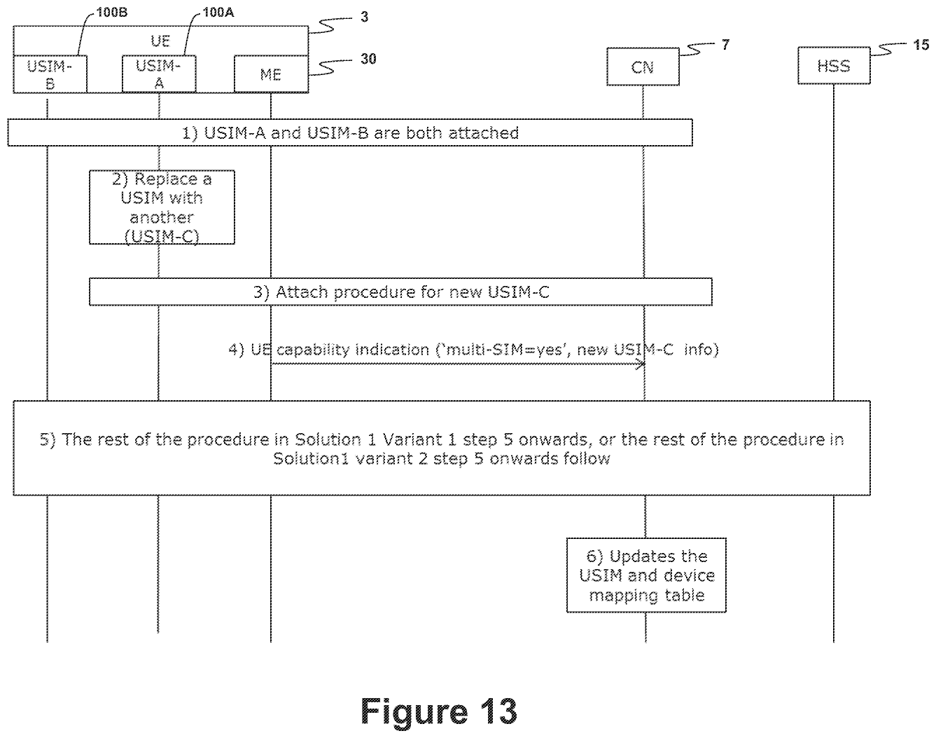

An exemplary procedure for reporting new USIM association information is shown in FIG. 13.

1. In this example, both USIM-A 100A and USIM-B 100B are initially in the ME 30 and are attached to the network as defined in 3GPP TS 23.401 [1] or TS 23.502 [3].

2. The end user replaces the USIM-A 100A in slot A with another USIM 100C (denoted as ‘USIM-C’ in FIG. 13) and enters the correct PIN to activate USIM-C 100C.

3. The UE 3 and the network completes the successful attach procedure for USIM-C 100C.

4. The UE 3 reports to the CN 7 (AMF, for example) that the USIM association has changed in the ME 30 by sending UE Capability Information message, for example. In the example shown in FIG. 13, the UE 3 communicates using the subscription associated with USIM-8 100B. At this time, the UE 3 provides subscription information for USIM-C 100C, e.g. the IMSI of USIM-C 100C. Alternatively, the UE 3 may communicate using the subscription of USIM-C 100C and provide subscription information for USIM-B 100B, e.g. the IMSI of USIM-8 100B.

5. The CN 7 (AMF, for example) triggers the procedure shown in FIG. 6, FIG. 7, FIG. 8, or FIG. 9, from step 5 onward.

6. The CN 7 (AMF, for example) updates the mapping table between the USIM 100 and the device 30 as shown in FIG. 12, for example, using the latest information obtained in this procedure.

Solution 2, Variant 2: Re-Verification Based on Timer Expiration

In this solution variant, the CN 7 (AMF, for example) holds a timer which defines the period for which the CN 7 considers the USIM association to be valid. Upon expiration of this timer, the CN 7 re-initiates the verification procedure as described in solution 1 above.

The exact timer value of this timer can be either static in the system or dynamically configurable based on operator preference, for example.

If neither USIMs 100 is replaced since the last verification as described in solution 1 in this disclosure, then the CN 7 (AMF, for example) arrives at the same conclusion and the same USIM information as the previous verification. On the other hand, if any of the USIM 100 is replaced since the last verification (as described in solution 1 above), then the CN 7 arrives at new association of different USIMs 100. In this case, the CN 7 discards the previous association information and stores the new association information.

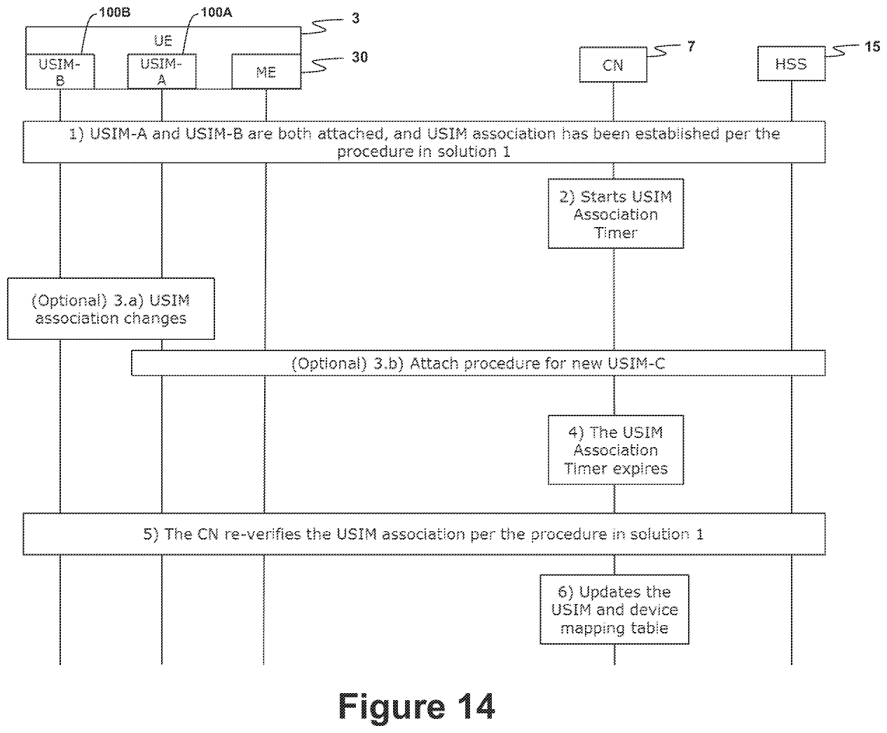

An exemplary procedure for a timer based re-verification is shown in FIG. 14.

1. As a pre-condition, both the first USIM 100A and the second USIM 100B are in the ME 30 and are attached to the network as defined in 3GPP TS 23.401 [1] or TS 23.502 [3].

2. The CN 7 (AMF, for example) starts a timer (denoted for example as a ‘USIM association timer’) at the end of the verification procedure as described in solution 1 above. The timer may be set to a predetermined starting value and count down to zero or it may be set to zero and count up to a predetermined end value.

3. (optional) The end user replaces the USIM 100 in either slot in the ME 30 with a different USIM 100C (denoted ‘USIM-C’ in FIG. 14) and enters the correct PIN to activate the new USIM 100C. This triggers the UE 3 and the network to successfully perform an attach procedure for the new USIM 100C. It will be appreciated that after a successful attach procedure the timer may be reset by the CN 7 (i.e. step 2 may be performed again).

It should be noted that this optional step does not occur if the end user kept the USIMs 100 as-is and thus does not change the USIM 100 in the ME 30.

4. The USIM Association Timer expires (e.g. when an associated timer end value is reached, for example ‘0’ when counting down).

5. The CN 7 (AMF, for example) triggers the re-verification procedure as described in solution 1 above. At this time, if the optional step 3 did not occur, then the CN 7 arrives at the same association of the same USIMs 100 as in the previous verification. However, if the optional step 3 did occur, then the CN 7 arrives at new association of different USIMs 100. At this time, the CN 7 discards the previous USIM association information and stores the new USIM association information.

6. The CN 7 (AMF, for example) updates the mapping table between the USIM 100 and the device as shown in FIG. 12, for example using the latest information obtained in this procedure.

Solution 3: Verification of USIM Information Through Coordination Across Multiple MNOs

This solution (embodiment) aims to address the issue of identifying USIMs 100 in a multi-SIM device when multiple MNOs are involved. Specifically, this solution allows verification of USIMs 100 by exchanging information across multiple MNOs. This scenario is relevant if the USIMs 100 in the multi-SIM device 30 are subscribed to different MNOs that have business relationship with each other, such as roaming partners in different countries.

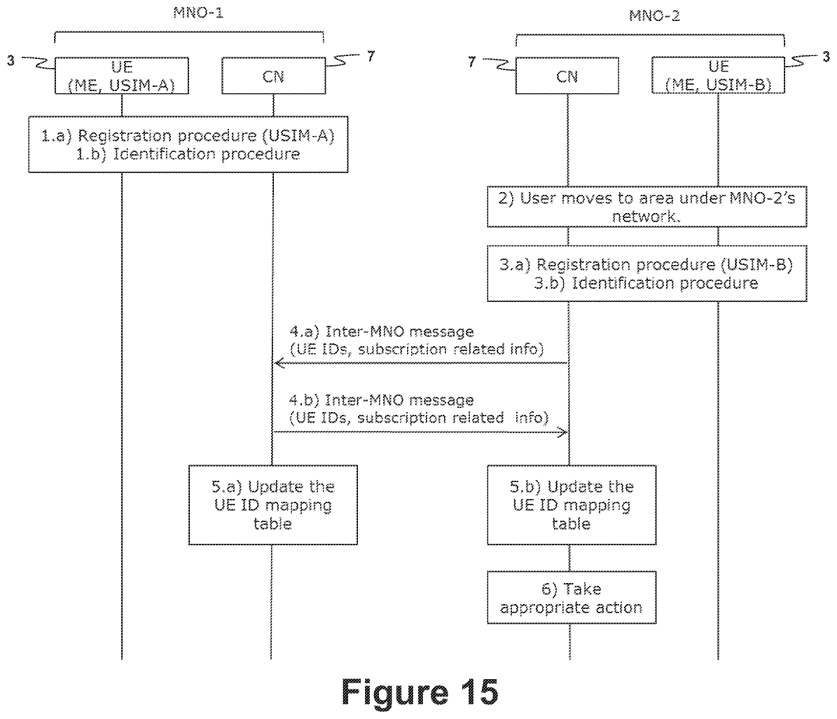

For example, MNO-1 in FIG. 15 is the H-PLMN of the user in his/her home country, and the MNO-2 is the MNO-1's roaming partner PLMN in another country. In this example, the first USIM 100A has a subscription from the MNO-1 (USIM-A's H-PLMN), and the second USIM 100B has a subscription from the MNO-2 (USIM-B's H-PLMN).

An exemplary procedure in accordance with this solution is shown in FIG. 15.

1. The user is under MNO-1 (USIM-A's H-PLMN) and the UE 3 registers itself with MNO-1 using the first USIM's 100A subscription information. The CN 7 (AMF, for example) in MNO-1 obtains the UE mapping information using Identification procedure as in 3GPP TS 23.401 [2], TS 23.501 [3], TS 24.301 [4], or TS 24.501 [5], for example. In the Identification procedure, the CN 7 queries the IMSI and IMEI of USIM-A 100A, and at least either the IMSI or IMEI of USIM-B 100B. The Identification procedure may be repeated multiple times to query one identity at a time as in the existing specifications in [4] and [5]. Alternatively, the procedure can be expanded to query multiple identities in one request and response message exchange, for example, to query different types of identities from the same subscription (e.g. IMSI and IMEI of USIM-A 100A) or same type of identities from different subscriptions (IMEI of USIM-A 100A and USIM-B 1008), for example.

2. The user moves to an area under MNO-2's network.

3. The UE 3 registers itself with MNO-2 using the second USIM's 100B subscription information. The CN 7 (AMF, for example) in MNO-2 obtains the UE mapping information using Identification procedure as in 3GPP TS 23.401 [2], TS 23.501 [3], TS 24.301 [4], or TS 24.501 [5], for example. In the Identification procedure, the CN 7 queries the IMSI and IMEI of USIM-B 100B, and at least either IMSI or IMEI of USIM-A 100A. The Identification procedure may be repeated multiple times to query one identity at a time as in the existing specifications in TS 24.301 [4] and TS 24.501 [5]. Alternatively, the procedure can be expanded to query multiple identities in one request/response message exchange, for example, to query different types of identities from the same subscription (e.g. IMSI and IMEI of USIM-B 100B) or same type of identities from different subscriptions (IMEI of USIM-A 100A and USIM-B 100B), for example.

In this example, The MNO-2 queries the IMSI of USIM-A 100A. By looking at the PLMN-ID (MCC and MNC) part of the IMSI of MNO-1, the MNO-2 identifies that the MNO-1 needs to be contacted in the following step.

4. MNO-2 communicates with MNO-1 using the UE identities established in step 3, for example, the mapping information between the IMSI and IMEI of USIM-8 100B by sending Inter-MNO message, for example. At this time, MNO-2 includes, if applicable, associated subscriber related information, such as whether or not service is being blocked to the subscription in USIM-B 100B, for example, due to lost or stolen device. Similarly, MNO-1 communicates with MNO-2 using the UE identities established in step 1, for example, the mapping information between the IMSI and IMEI of USIM-A 100A by sending Inter-MNO Message, for example. At this time, MNO-1 includes, if applicable, associated subscriber related information, such as service is being blocked to the subscription in USIM-A 100A, for example, due to lost or stolen device. 5. Using the information received in step 4, both MNO-1 and MNO-2 update their own UE ID mapping table, as shown in FIG. 12, for example. After this step, both MNO-1 and MNO-2 have the same combined mapping information containing information for both USIM-A 100A and USIM-B 100B, for example, IMSI and IMEI value for USIM-A 100A, IMSI and IMEI value for USIM-8 100B, and subscriber related information such as whether the subscription is blocked or not for USIM-A 100A and USIM-B 100B.

6. The MNO-2 takes an appropriate action based on the mapping information established in step 5. In one example, MNO-2 receives that MNO-1 has already blocked the service to the subscription associated with USIM-A 100A. In this case, MNO-2 also applies the same rule and blocks the subscription for USIM-B 100B. In another example, the subscriber related information from MNO-1 indicates that the subscription for USIM-A 100A was formerly blocked but now changed to unblocked. In this case, the MNO-2 also unbiocks the subscription to USIM-B 100B.

### SUMMARY

Beneficially, the above described exemplary embodiments include, although they are not limited to, one or more of the following functionalities.

Solution 1, Variant 1:
1) Cryptographic operation using subscription-unique information to establish that the USIMs in the multi-SIM device are indeed in the device.
2) Cross-application of the unique permanent keys from multiple USIMs in a series of cryptographic operations in order to generate a transformed value as a way to fuse elements of multiple subscription information together.
3) Cryptographic operation using the unique keys from multiple subscriptions assures that the cryptographically transformed value is uniquely derived from the specific USIMs. 4) The functionality in 1) is done in such a way that only the genuine USIMs and CN themselves can execute the operation yielding the correct result so that no 3^{rd} party entity or compromised entity (e.g. malicious ME) can impersonate the genuine USIM and ME.

Solution 1, Variant 2, Variant 3:
1) Cryptographic operation using the dynamically-created security context of the subscription after the subscription associated with USIM is fully authenticated to establish that the USIMs in the multi-SIM device are indeed in the device.
2) Cross-application of the dynamically-created security context from multiple USIMs in a series of cryptographic operation in order to generate a transformed value as a way to fuse elements of multiple subscription information together.
3) Cryptographic operation using the unique key from multiple subscriptions assures that the cryptographically transformed value is uniquely derived from the specific USIMs.
4) The functionality in 1) is done in such a way that only the ME having access to the genuine USIMs and CN themselves can execute the operation yielding the correct result so that no 3^{rd} party entity or compromised entity (e.g. malicious UE) can impersonate the genuine USIM and ME.

Solution 1, Variant 4 and Variant 5:
1) Cryptographic operation using the NAS security context of the subscription after the subscription associated with USIM is fully authenticated to establish that the USIMs in the multi-SIM device are indeed in the device.
2) Cross-application of the dynamically-created security context from multiple USIMs in a series of cryptographic operation in order to generate a transformed value as a way to fuse elements of multiple subscription information together.
3) Cryptographic operation using the unique key from multiple subscriptions assures that the cryptographically transformed value is uniquely derived from the specific USIMs.
4) The functionality in 1) is done using signaling over multiple NAS connections associated with multiple subscriptions associated with USIMs.
5) The functionality in 1) is done in such a way that only the ME having access to the genuine USIMs and CN themselves can execute the operation yielding the correct result so that no 3^{rd} party entity or compromised entity (e.g. malicious UE) can impersonate the genuine USIM and ME.

Solution 2, Variant 1:
1) The ME detects a change of one or more USIM, and indicates this change to the network.
2) The ME's detection of the change of USIM triggers the network to re-verify the USIM association in the ME to make the mapping information in the network up-to-date.

Solution 2, Variant 2:
1) The expiration of CN timer (USIM Association Timer) triggers the USIM verification procedure to make the mapping information in the network up-to-date.
2) The use of CN timer ensures periodic re-verification of USIM association in the ME to keep the USIM mapping information in the network up-to-date.

Solution 3:
1) When the MNO obtains the subscriber information of the respective USIM and the other USIM, the MNO sends its subscriber information, such as IMSI, IMEI, and operator-specific status information to the other MNO the other USIM is a subscriber of. The operator-specific status information may contain such as the subscriber being barred from service due to various reason (subscriber with delinquent subscription fee, etc.).

2) The exchange and sharing of subscriber information between the MNOs allows the MNOs to apply the same handling to the user of these subscriptions, such as termination of ongoing call, or blocking or unblocking of service.

Benefits

Some of the benefits associated with the above described embodiments include, although not limited to, one or more of the following:

1. The network can unambiguously identify and verify the identities of the USIMs inserted in the mobile device and correlate them to device identity (IMEI(s)).

2. Using the above described methods, it is not possible for the ME or any 3rd party entity to lie about the identity of the USIMs and the associated subscription. This is ensured by methods such as use of permanent key stored in the USIM and server for subscription data, or use of dynamically derived security context as the result of successful mutual authentication between the network and the UE, to transform a token. In other words, the use of shared secret, which only the legitimate UE (USIMs and ME) and network, can only successfully execute the operation described in this disclosure, thus preventing 3rd party entity to impersonate a subscription or mobile device.

3. The network can correlate the subscriptions associated with USIMs in the mobile device and carry out necessary administrative operation against the user. For example, if one subscription is blocked, then the other subscription in the same mobile device can also be blocked. This way, the above described mechanisms satisfy the relevant GSMA requirements. It will be appreciated that these benefits may be achieved even when the subscriptions of USIMs are from different operators (e.g. roaming partner operators in 2 different countries).

Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

The messages shown in the procedure in FIGS. 6, 7, 8, and 9 are for illustration purpose to describe the method in the given disclosure. However, it will be appreciated that the actual message names may be replaced by actual protocol message names in 5G, 4G (LTE) or earlier systems as defined (or to be defined) in the relevant 3GPP specifications. Network Elements (NE) names may also be replaced by the appropriate NE name that serves the equivalent functionality depending on the generation of mobile systems. For example, the CN in FIGS. 6, 7, 8, and 9 may be replaced by, for example, MSC in 2G (GSM) system, RNC in 3G (UMTS) system, MME in 4G (LTE) system, or AMF in 5G system. Also, the HSS 15 in FIG. 6 may be replaced by a HLR in 2G, 3G, 4G (GSM, UMTS, LTE) systems or a UDM in 5G systems. It will also be appreciated that the HSS 15 may be replaced by an EIR in order to maintain the IMEI of the subscribers.

In the above embodiments, the encryption function used in the USIM 100 and the server for subscription data (solution 1 variant 1) or in the ME 30 and the CN 7 (solution 1 variant 2 through variant 6) comprises a symmetric cryptographic function, such as EEA0, EEA1, EEA2, EEA3 as defined in 3GPP TS 33.401 [6] or NEA0, NEA1, NEA2, NEA3 as defined in 3GPP TS 33.501 [7]. Alternatively, it may comprise any other suitable symmetric cryptographic algorithm that is supported in both the USIM 100 and the server for subscription data (in solution 1 variant 1) or the ME 30 and the CN 7 (in solution 1 variant 2 through variant 6).

Further, it will be appreciated that the symmetric cryptographic algorithm used in the USIM 100 and the server for subscription data (solution 1 variant 1) or in the ME 30 and the CN 7 (solution 1 variant 2 through variant 6) may be pre-determined in these entities or dynamically signaled to them at the time of cryptographic operation.

The verification mechanism described in solution 1 variant 1 employs an encryption function using the permanent keys that are known only in the USIMs 100 and the server for subscription data. By definition, these permanent keys are neither accessible nor readable by the ME 30 or any other network elements. Due to the use of permanent keys, it is not possible for the ME 30 or any 3^{rd} party intermediate entity to forge the 2^{rd} or 3^{rd} order tokens which correctly de-generate into the original seed token. Therefore, the mechanism described in solution 1 variant 1 may be used to prevent security threats such as a “man-in-the-middle” (MitM) attack.

Similarly, the verification mechanisms described in solution 1 variant 2 through variant 6 employ an encryption function using the derived keys that are uniquely established for the subscription (USIM-A 100A and USIM-8 100B in FIGS. 7, 8, and 9, for example) after the NAS security context is established for these subscriptions. Therefore, it is theoretically not possible for any 3^{fd} party intermediate entity to forge the 2^{nd} or 3^{rd} order tokens which correctly de-generate into the original seed token. Therefore, the mechanisms described in solution 1 variant 2 through variant 6 may also be used to prevent security threats such as MitM attacks.

Therefore, using any of the verification mechanisms in these solution variants, if the ME 30 previously provided the USIM 100 subscription information (e.g. IMSI stored in the USIMs 100) by sending NAS messages to the CN 7, for example, it is not possible to lie about them.

In addition, if the permanent key (K) is used for the cryptographic operation (as described in solution 1 variant 1), it is independent of any specific generation of mobile system. Therefore, the above described verification mechanism may be applied in any generation of mobile systems, such as 5G, 4G (LTE), 3G (UMTS, or CDMA2000 or its variants), or 2G (GSM). It is not limited to any particular generation of system.

In the above description, the UE, the (R)AN node, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above embodiments are also applicable to ‘non-mobile’ or generally stationary user equipment.

The method performed by the UE may further comprise: receiving, from the network node, a second token (T_{B}) derived from the seed token (T_{S}) using the second cryptographic key (K_{B}, K_{NASenc_B}) associated with the second SIM; deriving a second third order token (T_{BA}) by encrypting the second token (T_{B}) using the first cryptographic key (K_{A}, K_{NASenc_A}) associated with the first SIM; and sending said second third order token (T_{BA}) to the network node.

The first cryptographic key (K_{A}, K_{NASenc_A}) associated with the first SIM may comprise at least one of a permanent key (K_{A}) associated with the first SIM and a UE specific key (K_{NASenc_A}) associated with the first SIM.

The second cryptographic key (K_{B}, K_{NASenc_B}) associated with the second SIM may comprise at least one of a permanent key (K_{B}) associated with the second SIM and a UE specific key (K_{NASenc_B}) associated with the second SIM.

The method performed by the UE may further comprise indicating to said network node that said UE comprises said first SIM and said second SIM upon at least one of: the UE performing an attach procedure with the network node using said first SIM or said second SIM; the UE detecting that at least one of said first SIM and said second SIM has been activated in said UE; and expiry of a timer associated with a third order token.

The third order tokens (TAB, TBA) may be derived by employing at least one predetermined cryptographic function to said first token (T_{A}) and/or said second token (T_{B}).

The UE may send said third order tokens (TAB, TBA) to the network node by sending at least one non-access stratum (NAS) message comprising at least one of said third order tokens (TAB, TBA). The UE may receive at least one of said first and second token (TA, TB) in a NAS message over a first connection associated with the first SIM and send at least one of said third order tokens (TAB, TBA) in a NAS message over a second connection associated with the second SIM.

The method performed by the network node may further comprise: sending, to said UE, a second token (T_{B}) derived from the seed token (T_{S}) using the second cryptographic key (K_{B}, K_{NAsenc_B}) associated with the second SIM; and receiving a second third order token (T_{BA}) derived by the UE by encrypting the second token (T_{B}) using the first cryptographic key (K_{A}, K_{NASenc_A}) associated with the first SIM.

The third order tokens (TAB, TBA) may be used by the network node in verifying whether said first SIM and said second SIM are comprised in said UE. The verification by the network node may comprise at least one of: deriving a first de-transformed token (TX) by decrypting said first third order token (T_{AB}) using, in sequence, the second cryptographic key (K_{B}, K_{NAsenc_A}) and the first cryptographic key (K_{A}, K_{NASenc_A}), and comparing said first de-transformed token (TX) to the seed token (T_{S}); and deriving a second de-transformed token (TY) by decrypting said second third order token (T_{BA}) using, in sequence, the first cryptographic key (K_{A}, K_{NASenc_A}) and the second cryptographic key (K_{B}, K_{NASenc_B}); and comparing said second de-transformed token (TY) to the seed token (T_{S}).

The method performed by the network node may further comprise determining that at least one of said first SIM and said second SIM is to be blocked, and blocking both said first SIM and said second SIM when it has been verified that said first SIM and said second SIM are comprised in the UE.

The method performed by the network node may further comprise sending at least one of said first and second token (TA, TB) in a NAS message over a first connection associated with the first SIM and receiving at least one of said third order tokens (TAB, TBA) in a NAS message over a second connection associated with the second SIM.

The method performed by the network node associated with the first MNO may further comprise blocking said first SIM card when said received information indicates that said second SIM is blocked.

The above cryptographic functions and keys (K_{A}, K_{B}, K_{NASenc_A}, K_{NASenc_B} etc.) are used as examples only and any suitable function and key may be used by the UE and the network node. In particular, the keys K_{A}, K_{B} etc. are intended to represent any cryptographic keys that are appropriate in a given system. They are not to be construed as limiting the scope of the claims to any specific type of keys.

Various other modifications will be apparent to those skilled in the art and will not be described in further detail here.

### Abbreviations

3GPP 3^{rd} Generation Partnership Project
4G 4^{th} Generation
5G 5th Generation
5GC 5th Generation Core network
AN Access Network
AS Access Stratum
CP Control Plane
DL DownLink
DRB Data Radio Bearer
DSDS Dual SIM Dual Standby
DSDA Dual SIM Dual Active
EEA EPS Encryption Algorithm
EIR Equipment Identity Register
EPC Evolved Packet Core (4G core network)
EPS Evolved Packet System
eSIM embedded SIM
E-UTRA Evolved Universal Terrestrial Radio Access
eNB Evolved NodeB (4G base station)
gNB Next-Generation NodeB (5G base station)
GSMA Groupe Spéciale Mobile (GSM) Association
HLR Home Location Register
H-PLMN Home Public Land Mobile Network
HSS Home Subscriber Server
IMEI International Mobile Equipment Identity
IMSI International Mobile Subscriber Identity
MCC Mobile Country Code
ME Mobile Equipment
MitM Man-in-the-Middle
MNC Mobile Network Code
MNO Mobile Network Operator
NAS Non-Access Stratum
NEA Encryption Algorithm for 5G
NG Next Generation
NR Next-generation Radio
PLMN Public Land Mobile Network
PLMN-ID Public Land Mobile Network Identity
RAN Radio Access Network
RAT Radio Access Technology
RB Radio Bearer
RNG Random Number Generator
SIM Subscriber Identity Module
TGF Token Generation Function
TS Technical Specification
UDM Unified Data Management
UE User Equipment
UL UpLink
UP User Plane
UICC Universal Integrated Circuit Card
USIM Universal Subscriber Identity Module
Uu Interface between the base station and the UE
V-PLMN Visited Public Land Mobile Network

### LIST OF REFERENCES

[1] 3GPP TS 23.401, Ver. 15.6.0, “General Packet Radio Service (GPRS) enhancements for Evolved Universal Terrestrial Radio Access Network (E-UTRAN) access”
[2] 3GPP TS 23.501, Ver. 15.4.0, “System architecture for the 5G System (5GS)”
[3] 3GPP TS 23.502, Ver. 15.4.1, “Procedures for the 5G System (5GS)”
[4] 3GPP TS 24.301, Ver. 15.5.0, “Non-Access-Stratum (NAS) protocol for Evolved Packet System (EPS); Stage 3”
[5] 3GPP TS 24.501, Ver. 15.2.1, “Non-Access-Stratum (NAS) protocol for 5G System (5GS); Stage 3”
[6] 3GPP TS 33.401, Ver. 15.6.0, “3GPP System Architecture Evolution (SAE); Security architecture”
[7] 3GPP TS 33.501, Ver. 15.3.1, “Security architecture and procedures for 5G system”
[8] 3GPP TS 31.101, Ver. 15.1.0, “UICC-terminal interface; Physical and logical characteristics”
[9] 3GPP TS 31.102, Ver. 15.3.0, “Characteristics of the Universal Subscriber Identity Module (USIM) application”
[10] GSMA TS.37, Ver. 5.0, “Requirements for Multi SIM Devices”, 4 Dec. 2018

What is claimed is:

1. A method performed by a user equipment (UE) comprising at least a first Subscriber Identity Module (SIM) and a second SIM, the method comprising:
receiving, from a network node, at least a first token derived from a seed token using a first cryptographic key associated with the first SIM;
deriving a first third order token by encrypting the received first token using a second cryptographic key associated with the second SIM; and
sending said third order token to the network node.

2. The method according to claim 1, further comprising:
receiving, from the network node, a second token derived from the seed token using the second cryptographic key associated with the second SIM;
deriving a second third order token by encrypting the second token using the first cryptographic key associated with the first SIM; and
sending said second third order token to the network node.

3. The method according to claim 1, wherein said first cryptographic key associated with the first SIM comprises at least one of a permanent key associated with the first SIM and a UE specific key associated with the first SIM.

4. The method according to claim 1, wherein said second cryptographic key associated with the second SIM comprises at least one of a permanent key associated with the second SIM and a UE specific key associated with the second SIM.

5. The method according to claim 2, wherein said third order tokens are for use by said network node in verifying whether said first SIM and said second SIM are comprised in said UE.

6. The method according to any, claim 1, further comprising indicating to said network node that said UE comprises said first SIM and said second SIM upon at least one of:
the UE performing an attach procedure with the network node using said first SIM or said second SIM;
the UE detecting that at least one of said first SIM and said second SIM has been activated in said UE; and
expiry of a timer associated with a third order token.

7. The method according to claim 2, wherein said deriving said third order tokens comprises employing at least one predetermined cryptographic function to said first token and/or said second token.

8. The method according to claim 2, wherein said sending said third order tokens to the network node comprises sending at least one non-access stratum (NAS) message comprising at least one of said third order token.

9. The method according to claim 2, comprising receiving at least one of said first and second token in a NAS message over a first connection associated with the first SIM and sending at least one of said third order tokens in a NAS message over a second connection associated with the second SIM.

10. A method performed by a network node communicating with a user equipment (UE) comprising at least a first Subscriber Identity Module (SIM) and a second SIM, the method comprising:
sending, to said UE, at least a first token derived from a seed token using a first cryptographic key associated with the first SIM; and
receiving, from said UE, a first third order token derived by the UE by encrypting the first token using a second cryptographic key associated with the second SIM.

11. The method according to claim 10, further comprising:
sending, to said UE, a second token derived from the seed token using the second cryptographic key associated with the second SIM; and
receiving a second third order token derived by the UE by encrypting the second token using the first cryptographic key associated with the first SIM.

12. The method according to claim 11, further comprising verifying, based on at least one of said third order tokens, whether said first SIM and said second SIM are comprised in the UE.

13. The method according to claim 12, wherein said verifying comprises at least one of:
deriving a first de-transformed token by decrypting said first third order token using, in sequence, the second cryptographic key and the first cryptographic key, and comparing said first de-transformed token to the seed token; and
deriving a second de-transformed token by decrypting said second third order token using, in sequence, the first cryptographic key and the second cryptographic key; and comparing said second de-transformed token to the seed tokens.

14. The method according to claim 12, further comprising determining that at least one of said first SIM and said second SIM is to be blocked, and blocking both said first SIM and said second SIM when it has been verified that said first SIM and said second SIM are comprised in the UE.

15. The method according to claim 11, comprising sending at least one of said first and second token in a NAS message over a first connection associated with the first SIM and receiving at least one of said third order tokens in a NAS message over a second connection associated with the second SIM.

16-19. (canceled)

20. A user equipment (UE) comprising at least a first Subscriber Identity Module (SIM) and a second SIM, a memory storing instructions, and one or more processors,
wherein the one or more processors configured to execute the instructions to:
receive, from a network node, at least a first token derived from a seed token using a first cryptographic key associated with the first SIM;
derive a first third order token by encrypting the received first token using a second cryptographic key associated with the second SIM; and
send said third order token to the network node.

21. A network node communicating with a user equipment (UE) comprising at least a first Subscriber Identity Module (SIM) and a second SIM, the network node comprising a memory storing instructions, and one or more processors,
wherein the one or more processors configured to execute the instructions to:
send, to said UE, at least a first token derived from a seed token using a first cryptographic key associated with the first SIM; and
receive, from said UE, a first third order token derived by the UE by encrypting the first token using a second cryptographic key associated with the second SIM.

22-24. (canceled)
